(19) United States
(12) Patent Application Publication
(10) Pub. No.: US 2004/0072091 A1
(43) Pub. Date: Apr. 15, 2004

(54) Developer for developing electrostatic image, image forming apparatus and image forming method

(76) Inventors: Satoshi Mochizuki, Shizuoka (JP); Hideki Sugiura, Shizuoka (JP); Shinya Nakayama, Shizuoka (JP); Kazuhiko Umemura, Shizuoka (JP); Yasuo Asahina, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/615,770

(22) Filed: Jul. 10, 2003

(30) Foreign Application Priority Data
Jul. 10, 2002 (JP) 2002-201970

(51) Int. Cl. G03G 9/08

(52) U.S. Cl. 430/108.7; 430/108.1; 430/110.3; 430/126

(57) ABSTRACT

A developer, which includes a base toner containing at least a binding resin and a coloring agent; and inorganic fine particles; wherein the base toner satisfies 105≦SF-1≦130 and 120≦SF-2≦180, wherein SF-1=((absolute maximum length of a particle of the base toner)²/area of the particle of the base toner)×(π/4)×100, wherein SF-2=(peripheral length of the particle of the base toner)²/(area of the base toner)×(¼π)×100, wherein the inorganic fine particles have an average particle diameter that ranges between 30 nm to 160 nm.

### BACKGROUND OF THE INVENTION

1. Field of the Invention

This invention relates to a developer for developing electrostatic images, an image forming apparatus including the developer, an image forming method including the developer, and a process cartridge including the developer.

2. Description of the Related Art

Representative image forming methods as an electrophotographic method or an electrostatic method include a development process, a transfer process, and a fixation process. In the development process: a photoconductive insulating layer is uniformly charged; the insulating layer is then exposed so that electric charges on the exposed portions are dispersed to form an electric latent image; and the latent image is then made visible by adhering particles of toner powder carrying electric charge. In the transfer process, the obtained visible image is transferred to a transfer medium such as transfer paper. In the fixation process, the transferred image is fixed by applying heat or pressure thereto (typically, a thermal roller is used). A dual component developer comprising a carrier and a toner or a single component developer requiring no carrier (e.g. magnetic toner, non-magnetic toner) are commonly known developers used in developing an electrostatic image on a surface on which a latent image is maintained. In a well known method for a full color image forming apparatus, toner images for each color are first transferred to an intermediary transfer body, respectively and temporarily maintained on the intermediary transfer body, and then, the toner images are further transferred collectively onto paper.

Binder resin and colorants (coloring agents) are employed as the main components of the toners (developers) used for the electrophotographic method and the electrostatic method, and the toners may also include an additive such as an electric charge controlling agent, and an offset resistance agent. Such toners are required to provide various performances in correspondence to the aforementioned processes. For example, in the developing process, a toner or a binder resin used for a toner is required to maintain a suitable amount of electric charge for a copier or a printer while being resistant to environmental factors (e.g. temperature, humidity) so that the toner may suitably adhere to an electric latent image. In the fixation process where a thermal roller is used for fixation, toner may also be required to acquire an anti-offset property for not adhering to a thermal roller which is generally heated to a temperature of approximately 100° C. to 230° C., or a fixation property for fixing onto paper. Furthermore, toner may be required to acquire a blocking resistant property for preventing the toner from blocking while the toner is preserved inside a copy machine.

Furthermore, recently in the field of electrophotography, techniques for providing high grade images are being studied from various aspects. Among such techniques, a technique of providing a toner with a smaller diameter and also a technique of forming a toner into a spherical shape has been recognized to be extremely effective. However, as the diameter of a toner becomes smaller, transfer efficiency tends to degrade, thereby resulting to poor images. It is, however, known that transfer efficiency can be improved by forming a toner into a spherical shape (Refer to Japanese laid-open patent application No. 9-258474). Meanwhile, under these circumstances, a faster image forming technique is desired in the field of color copy machines and color printers.

In means to form images faster, a tandem method is effective (Refer to Japanese laid-open patent application No. 5-341617). With the tandem method, images formed with an image forming unit are transferred successively onto a single transfer sheet in an overlapped manner, to thereby form a full color image on the transfer sheet. A color image forming apparatus using the tandem method has excellent properties such as being able to use a wide variety of transfer paper, being able to provide a full color image of high grade, and being able to obtain a full color image at high speed. The property obtaining a full color image at high speed is particularly a property which color image forming apparatuses using other methods do not have.

Although a method of providing high grade images by using a spherical toner has been proposed, the method is not put to practical use due to difficulty in cleaning. Conventionally, a technique of employing a toner with a bent spherical shape has been proposed. For example, with reference to Japanese laid-open patent application 61-279864, a toner with SF-1 of 120 to 180 and SF-2 of 110 to 130 is proposed. Furthermore, with reference to an image forming method using an intermediary transfer body described in Japanese laid-open patent application No. 8-328312, a toner having an SF-1 of 110≦SF-1≦180 and an SF-2 of 110≦SF-2≦140 is proposed, in which a ratio (B/A) between B (value obtained by subtracting 100 from SF-2) to A (value obtained by subtracting 100 from SF-2) is a value no more than 1.0. Both of the proposed toners are aimed to improve cleaning efficiency and transfer efficiency by increasing the value of SF-1 (bending of the spherical shape). Nevertheless, bending a toner from a spherical shape tends to cause transfer difficulty and create poor images since the toner is unable to uniformly fill a latent image on a photoconductor in a manner as that of a spherical toner.

Furthermore, attempts are also being made for providing high grade images while also achieve high speed image forming with use of a spherical toner. In order to achieve high speed image forming with the aforementioned technique, an increase in transfer pressure is necessary for obtaining the same performance as the aforementioned technique since the time for a sheet of paper to pass a transfer portion is required to be reduced. However, with the increase in transfer pressure, the pressure during transfer causes cohesion of toner and restricts suitable transfer, thereby raising a problem of creating blanks in the formed image. In order to solve the problem, Japanese laid-open patent application No. 2000-3063, for example, proposes to provide high grade images by defining the degree of roundness, a particle diameter, a specific weight, and a BET ratio surface area for a toner in a case where adherent stress is no more 6 g/cm² when the toner is compressed to 1 kg/cm². However, in a case of employing the adherent stress where toner is compressed under 1 kg/cm2, the compression stress was too weak. Therefore, in a case where transfer pressure is increased (e.g. when using OHP, thick paper, or surface coated paper), numerous problems were caused such as insufficient transfer efficiency and poor image quality, for example, creation of blank at a text portion. Furthermore, weak adherent stress causes problems such as creation of transfer dust. Furthermore, Japanese laid-open patent application No. 2000-352840 proposes to improve dischargeability by defining the adherent strength of one particle of a toner as no more than 3.0 dyne per contact point. This method, however, does not define adherent strength during compression. Therefore, although dischargeability of toner may be improved with this method, this does not solve problems such as insufficient transfer efficiency and poor image quality, for example, creation of blanks at a text portion.

Japanese registered patent No. 3002063 proposes a method of defining the degree of cohesion during compression for improving developing performance and stability of developing performance in relation to the passing of time. Defining the degree of cohesion during compression, however, has yet to resolve the problem of poor image quality, for example, creation of blanks at a text portion, and is still unable to sufficiently improve transferability and transfer rate. Furthermore, Japanese laid-open patent application No. 2000-267422 proposes to prevent creation of blanks at a text portion by satisfying an equation of A×B≦7 (where A denotes degree of cohesion and B denotes apparent loose density). This method, however, does not consider behavior of physical property during toner compression, and is therefore insufficient for systems which apply much stress to a toner such as a system performing intermediary transfer or a system developing with forceful agitation. Furthermore, Japanese laid-open patent application No. 2000-352840 describes a method where the ratio of apparent loose density to apparent hardening density is 0.5 through 1.0, and where the degree of cohesion is 25% or less. The apparent hardening density used in this case is a measured value of bulk density where tapping was conducted 50 times. This resulted to a physical property which relatively reflects fluidity, but was unable to reflect the increased bulk density when dynamic stress is applied to the toner. Results are also similar where a system applying further stress to a toner (e.g. a system performing intermediary transfer or a system developing with forceful agitation) is employed.

Meanwhile, in means to improve properties of a toner such as fluidity and chargeability, a method of mixing toner particles with, for example, inorganic powder such as various metal oxide material is proposed. In this case, the inorganic powder is called an external additive. Further, in a case where modification of, for example, hydrophobicity, or chargeability is required at a surface of the inorganic powder, methods such as a method of processing with use of , for example, a prescribed silane coupling agent, titanate coupling agent, silicone oil or organic acid, or a method of coating with a prescribed resin are also proposed. Some known examples of the inorganic powder are silicon dioxide (silica), titanium dioxide (titania), aluminum oxide, zinc oxide, magnesium oxide, cerium oxide, iron oxide, copper oxide, and tin oxide.

More particularly, hydrophobic silica fine particles are employed, in which the hydrophobic silica fine particles are formed by reacting silica or a titanium oxide fine particle with an organic silicide (e.g. dimethyldichlorosilane, hexamethyldisilazane, silicone oil), and then substituting the silanol group of the silica fine particle surface with an organic group.

Among the hydrophobic silica fine particle, silicone oil is known as a hydrophobic agent having sufficient hydrophobicity and providing excellent transferability from the low surface energy when included in a toner. In Japanese Publication No. 7-3600, and Japanese Patent No. 2568244, the degree of hydrophobicity is defined with processing silica with silicone oil. In Japanese laid-open publication No. 7-271087 and Japanese laid-open 8-29598, amount of adding silicone oil and carbon content inside the additive are defined. The amount of silicone oil content and the degree of hydrophobicity described in the foregoing publications is sufficient for applying a hydrophobic process to an inorganic fine particle serving as a base material for an external additive, and thus for providing a developer with a stable charging performance under highly humid conditions. Nevertheless, there were no attempts in using the significant characteristic of low surface energy of silicone oil for lowering adherence of a developer with respect to contacting members such as a contact charge apparatus, a developer carrier (sleave), a doctor blade, a carrier, an electrostatic latent image carrying body (photoconductor), or an intermediary transfer body. Problems such as forming of background stains due to strong adherence of a developer with respect to a photoconductor, and creation of blanks at text portions, line portions, dot portions, edge portions and central portions after transfer (portions not transferred by the developer), could not be improved just by adjustment of the adding amount or the degree of hydrophobicity of silicone oil. Furthermore, such adjustment could not improve problems as blank white areas where transfer cannot be achieved upon a concave portion of a transfer body having a convexo-concave surface. Furthermore, Japanese laid-open publication No. 11-212299 shows an inorganic fine particle containing a prescribed amount of silicone oil as a liquid element. Nevertheless, the defining of such amount was insufficient for satisfying the significant characteristic of silicone oil.

Meanwhile, a toner for electrophotography is required to provide a uniform and stable charge performance. Insufficient charge performance may cause problems such as staining and uneven density, thereby causing image quality to degrade. Along with size-reduction of image forming apparatuses, develop mechanisms are becoming smaller. Therefore, the rate of initial toner charge is becoming more important for providing high quality images. Many proposals have been made for achieving such high quality images. Some examples for improving chargeability with an additive for an electrophotographic toner are: a nonmagnetic single component developer containing an inorganic powder processed with silicone oil (Japanese Laid-open patent publication No. 3-294864); a magnetic single component developer having an additive coating ratio of 3%-30% with respect to a toner (Japanese Laid-open patent publication No. 4-204665); an electrostatic developer externally added to a toner having fine particles with a BET surface area ratio of 5-100 m²/g fixed on a surface thereof, and thus contained with particles with an surface area ratio which is 1.2 times or more than that of the fine particles fixed on the toner (Japanese Laid-open patent publication No. 4-33537); a developer using a nonmagnetic single component toner containing a hydrophobic silica fine powder and a prescribed hydrophobic titanium oxide (Japanese Laid-open patent publication No. 7-43930); and a developer having a toner additive comprising an organic-inorganic composite particle including an organic polymer structure and a polysiloxane structure(Japanese Laid-open patent publication No. 8-202071).

Nevertheless, these aforementioned examples were still insufficient for providing uniform charge and also were unable to provide a toner with sufficient initial charge. The amount of toner charge with respect to environmental conditions, especially humidity, was also insufficient. Many of the aforementioned examples typically used additives with increased hydrophobicity by surface processing oxide particles. Although the additives initially provide a desirable steady charge, the additives tend to deteriorate due to changes in composition, such as separation of additives along with the passing of time, or burial into the toner. Furthermore, with composite particles synthesized with a liquid phase method as shown in Japanese Laid-open patent publication No. 8-202071, the liquid catalyst material remaining inside the particles caused inadequate hydrophobicity or changes in hydrophobicity along with the passing of time.

Further, an electrophotographic toner additive having oxide particles obtained from oxidizing a solid solution including two or more types of elements is also known. With this electrophotographic toner, the minimum value in the difference of first ionization potential between the elements included in the solid solution is 1.20-4.20 eV, and the maximum value of first ionization potential in the element included in the solid element is 9.00 ev or less. Factors as the particle diameter and form of inorganic particles are not taken into much consideration in this case with the electrophotographic toner. Therefore, merely defining the ionization potential was insufficient in providing suitable fluidity, transferability and developer agitation for a toner.

Meanwhile, Japanese Laid-open patent publication No. 1-304467 shows a representative example of a method of manufacturing a toner. In this method, materials are mixed together at once and are then heated, melted, dispersed with use of a kneader or the like, to thereby form a uniform constituent. Then, the constituent is cooled, grinded, and classified, to thereby form a toner having a volume mean particle diameter of approximately 6-10 μm. Particularly, electrophotographic color toners used for forming color images have, in general, binder resins with various chromatic color dyes and pigments included therein. The performance required for obtaining color images is stricter compared to obtaining black images. In other words, besides the requirements of mechanical and electrical stability against external factors such as shock or humidity, color toners are required to provide expression of appropriate colors (color degree) as well as light permeability (transparency). Examples where dyes used as colorants are described in Japanese Laid-open publication Nos. 57-130043 and 57-130044. In such cases where dyes are used as colorants, clear color images can be obtained having excellent transparency and superb color development. Such dyes, however, have a problem of lacking light-fastness, and therefore, cause color to change or fade when subject to direct light.

Furthermore, among various image forming apparatuses, an image forming apparatus employing an intermediary transfer technique is known. With this image forming apparatus, a plurality of visible color development images, which are sequentially formed on an image carrying body, are transferred sequentially to an endless moving intermediary transfer body in an overlapped manner (first transfer), and then, the image transferred to the intermediary transfer body (toner image) is transferred as a whole to a transfer medium (second transfer). The intermediary transfer technique is used especially for color image forming apparatuses since the image forming apparatus employing the intermediary transfer technique provides the advantages of, for example, enabling size reduction, and having few restrictions regarding the kind of transfer medium used for transferring a final image thereto. However, this type of image forming apparatus may result to creation of blanks where no toner image of the color development images is transferred during the first transfer or the second transfer, thereby creating transfer blank portions in a final image on a transfer medium (e.g. transfer paper) at which no toner is transferred thereto. In a case of a solid image, the transfer blank portions are created with an area of a substantial size. In a case of a line image, the transfer blank portions are created in an intermittent manner. These irregular images tend to be created when forming four color full images. This is caused not only from the increased thickness of the toner layer, but also from a strong mechanical adherence other than coulomb's force (force other than electrostatic force such as Van del Waals force) which is created by contact pressure in-between the image carrying body surface and the toner, and in-between the intermediary transfer body surface and the toner. Furthermore, a filming phenomenon where a toner adheres upon a surface of the intermediary transfer body in a film-like manner may be caused due to increased adherence between the surface of the intermediary transfer body and the toner.

Accordingly, some techniques have been introduced to the market for preventing the creation of transfer blanks on images, for example, a technique of reducing adherence by applying a lubricant onto a surface of an image carrying body and also onto a surface of an intermediary transfer body, or a technique of reducing adherence of the toner itself by applying an external additive thereto. Nevertheless, with such techniques, factors such as increased contact pressure between toners or. tensile breakage strength during four color full image formation and high speed transfer are not taken into consideration. Therefore, such techniques lacked stability in image quality especially when transferring upon thick paper, surface coated paper, OHP film and the like.

Japanese laid-open patent application No. 8-211755 describes an art where transferability is enhanced and creation of irregular images with transfer blanks is prevented by adjusting the relative balance between the toner adherence of an image carrying body and the toner adherence of an intermediary transfer body. Nevertheless, the adherence in this case is described with a value obtained with a method using centrifugal force where the toner is in a powder state. Therefore, this resulted to a different material property compared to when contact pressure is increased.

Furthermore, after toners are manufactured, the toners are stored or transported under severe conditions such as environments of high temperature and high humidity, or environments of low temperature and low humidity. Accordingly, an effective means to preserve toners for preventing cohesion of toners, and deterioration of chargeability, fluidity, transferability, and fixation is also required.

### SUMMARY OF THE INVENTION

It is a general object of the present invention to provide a developer for developing electrostatic images, an image forming apparatus and an image forming method that substantially obviates one or more of the problems caused by the limitations and disadvantages of the related art.

More particularly, further objects of the present invention are given below.

(1) To provide a developer (toner) having steady performance even after outputting several tens of thousands of images.

(2) To supply a developer which may be subject to cleaning even with a spherical toner.

(3) To provide an electrophotographic developer, an image forming method including the developer, and an image forming apparatus including the developer in which the developer prevents burial of external additives into a toner, serves to sufficiently function as a fluidizing agent and a charge support agent, and provides steady chargeability and quality images, even in a case where the developer is agitated in a developing device for a long period.

(4) To provide an electrophotographic developer, an image forming method including the developer, and an image forming apparatus including the developer in which the developer is provided with suitable controlled adherence among toner particles when compressing and transferring a toner, is able to provide excellent transferability, developing performance, and fixation, is applicable to transfer media of various materials, and is able to provide high quality images.

(5) To provide an image forming apparatus and an image forming method for providing an image forming system which achieve excellent endurance and low maintenance.

(6) To provide an image forming apparatus and an image forming method which are able to transfer suitably when toner is compressed, to supply with sufficient fluidity when toner is not compressed, to start with excellent chargeability.

(7) To provide an image forming apparatus and an image forming method in which toner is transferred with excellent color representation, color resolution, color transparency, with steady gloss, and thus without unevenness.

(8) To provide an image forming apparatus preventing the creation of irregular images, for example, images with blanks, images with dust, or images with poor thin line reproduction, in which the image forming apparatus may be an image forming apparatus using a method of transferring a toner image formed on an electrostatic image carrying body onto an intermediary transfer body, and then transferring the toner image onto a transfer medium, or an image forming apparatus using a tandem method where images outputted with high speed.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a developer particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a developer, including a base toner containing at least a binding resin and a coloring agent; and inorganic fine particles; wherein the base toner satisfies 105≦SF-1≦130 and 120≦SF-2≦180, wherein SF-1=((absolute maximum length of a particle of the base toner)²/area of the particle of the base toner)×(π/4)×100, wherein SF-2=(peripheral length of the particle of the base toner)²/(area of the base toner)×(¼π)×100, wherein the inorganic fine particles have an average particle diameter that ranges between 30 nm to 160 nm.

Furthermore, with the developer of the present invention, the inorganic fine particles are formed as silica.

Furthermore, with the developer of the present invention, the inorganic fine particles are applied with a sol-gel technique and are thereby formed as spherical shaped hydrophobic silica fine particles.

Furthermore, with the developer of the present invention, the developer contains further inorganic fine particles having an average particle diameter which is smaller than the inorganic fine particles.

Furthermore, with the developer of the present invention, the developer is combined with a magnetic particle to function as a carrier.

Furthermore, an image forming apparatus of the present invention includes a developer for developing an electrostatic latent image formed on an electrostatic latent image carrier body to form a toner image; a transfer unit for transferring the toner image to a transfer medium; wherein the developer includes a further developer and a carrier, wherein the further developer has a base toner containing at least a binding resin and a coloring agent, and inorganic fine particles, wherein the carrier has a magnetic particle, wherein the base toner satisfies 105≦SF-1≦130 and 120≦SF-2≦180, wherein SF-1=((absolute maximum length of a particle of the base toner)²/area of the particle of the base toner)×(π/4)×100, wherein SF-2=(peripheral length of the particle of the base toner)²/(area of the base toner)×(¼π)×100, wherein the inorganic fine particles have an average particle diameter that ranges between 30 nm to 160 nm.

Furthermore, with the image forming apparatus of the present invention, the inorganic fine particles are formed as silica.

Furthermore, with the image forming apparatus of the present invention, the inorganic fine particles are applied with a sol-gel technique and are thereby formed as spherical shaped hydrophobic silica fine particles.

Furthermore, with the image forming apparatus of the present invention, the developer contains further inorganic fine particles having an average particle diameter which is smaller than the inorganic fine particles.

Furthermore, with the image forming apparatus of the present invention, the developer is combined with a magnetic particle to function as a carrier.

Furthermore, with the image forming apparatus of the present invention, the developer includes a plurality of colors.

Furthermore, a process cartridge of the present invention includes a charge unit charging a photoconductor; an exposure unit exposing light to the photoconductor to form an image on the photoconductor; a development unit developing the image formed on the photoconductor with a developer; a transfer unit transferring the image formed on the photoconductor to a transfer medium; a cleaning unit cleaning the transfer unit; wherein the developer includes a further developer and a carrier, wherein the further developer has a base toner containing at least a binding resin and a coloring agent, and inorganic fine particles, wherein the carrier has a magnetic particle, wherein the base toner satisfies of 105≦SF-1≦130 and 120≦SF-2≦180, wherein SF-1=((absolute maximum length of a particle of the base toner)²/area of the particle of the base toner)×(π/4)×100, wherein SF-2=(peripheral length of the particle of the base toner)²/(area of the base toner)×(¼π)×100, wherein the inorganic fine particle has an average particle diameter that ranges between 30 nm to 160 nm.

Furthermore, with the process cartridge of the present invention, the inorganic fine particles are formed as silica.

Furthermore, with the process cartridge of the present invention, the inorganic fine particles are applied with a sol-gel technique and are thereby formed as spherical shaped hydrophobic silica fine particles.

Furthermore, with the process cartridge of the present invention, the developer contains further inorganic fine particles having an average particle diameter which is smaller than the inorganic fine particles.

Furthermore, with the process cartridge of the present invention, the developer is combined with a magnetic particle to function as a carrier.

Furthermore, an image forming method of the present invention includes the steps of charging a photoconductor; exposing light to the photoconductor to form an image on the photoconductor; developing the image formed on the photoconductor with a developer; transferring the image formed on the photoconductor to a transfer medium; wherein the developer includes a further developer and a carrier, wherein the further developer has a base toner containing at least a binding resin and a coloring agent, and inorganic fine particles, wherein the carrier has a magnetic particle, wherein the base toner satisfies 105≦SF-1≦130 and 120≦SF-2≦180, wherein SF-1=((absolute maximum length of a particle of the base toner)²/area of the particle of the base toner)²×(π/4)×100), wherein SF-2=(peripheral length of the particle of the base toner/area of the base toner)×(¼π)×100, wherein the inorganic fine particles have an average particle diameter that ranges between 30 nm to 160 nm.

Furthermore, with the image forming method of the present invention, the inorganic fine particles are formed as silica.

Furthermore, with the image forming method of the present invention, the inorganic fine particles are applied with a sol-gel technique and are thereby formed as spherical shaped hydrophobic silica fine particles.

Furthermore, with the image forming method of the present invention, the developer contains further inorganic fine particles having an average particle diameter which is smaller than the inorganic fine particles.

Furthermore, with the image forming method of the present invention, the developer is combined with a magnetic particle to function as a carrier.

Other objects and further features of the present invention will be apparent from the following detailed description when read in conjunction with the accompanying drawings.

### BRIEF DESCRIPTION OF THE DRAWINGS

FIG. 1 is a schematic structural view showing an example of an image forming apparatus according to the present invention;

FIG. 2 is a schematic structural view showing another example of an image forming apparatus according to the present invention;

FIG. 3 is a schematic structural view showing further another example of an image forming apparatus according to the present invention;

FIG. 4 is a schematic structural view showing further another one example of an image forming apparatus according to the present invention;

FIG. 5 is a schematic structural view showing further another one example of an image forming apparatus according to the present invention;

FIG. 6 is a schematic structural view showing further another one example of an image forming apparatus according to the present invention;

FIG. 7 is a schematic view showing a process cartridge including the developer of the present invention; and

FIG. 8 is a schematic view showing an image forming apparatus having a process cartridge including the developer of the present invention.

### DESCRIPTION OF THE PREFERRED EMBODIMENTS

In the following, embodiments of the present invention will be described with reference to the accompanying drawings.

With the developer of the present invention: cleaning can be performed even for a toner having a spherical shape; external additives can be prevented from being buried into the toner even after the toner is stored in an environment of high temperature and high humidity; the developer can sufficiently function as a fluidity agent and a supplementary charging agent; steady image quality can be provided by restraining an irregular increase in chargeability even after the developer is preserved in an environment of low temperature and low humidity; cohesion when toner is compressed upon transfer can be controlled; and adherence between toner particles, after being applied with stress inside a develop apparatus, can be controlled; and excellent transferability and development performance can be achieved; thereby forming images with high quality.

Although the mechanism of the developer is yet to be studied, the following assumptions may be made according to several analyzed datum. That is, even in a case where the SF-2 is 120 to 180 and where the toner has a concavo-convex surface, the following effects may be achieved by using inorganic fine particles having a mean particle diameter of 30 nm to 160 nm, in which the effects are that: additives can be prevented from being buried into the toner; direct contact between toner particles and a photoconductor can be prevented; and both direct electrostatic adherence and physical adherence between the toner particles and the photoconductor can be reduced. Accordingly, cleaning can be suitably performed. Furthermore, the developer can serve as a spacer for preventing cohesion among toners. The developer can also prevent additives from being buried into the toner when the toner is preserved under high temperature, or when there is little agitation of toner. This effect can be achieved more significantly as the particle diameter of the toner becomes smaller. It is particularly effective when the particle diameter of the toner is no more than 7 μm. Furthermore, a greater effect can be achieved when the circle degree of the toner is no less than 0.95 and no more than 0.996, which is a state where the shape of the toner is substantially a sphere.

Furthermore, the following effects can be achieved by mixing the toner with the inorganic fine particle and one or more types of external additive(s) having a smaller mean primary particle diameter(s) than the inorganic fine particle, in which the effects are: an increased fluidity, which could not have been obtained solely with the inorganic fine particle having a large particle diameter of 30 nm to 160 nm, can be obtained; coating ratio of the external additive relative to the toner can be improved; affinity between external additives can be enhanced; and the adhering state of the external additive can be improved. Furthermore, the inorganic fine particle having a large particle diameter serves as a spacer so that: inorganic fine particles can be prevented from being buried into the toner upon deterioration of the toner, which tends to be caused when there is little incoming and outgoing toner; spent toner can be prevented; and fluidity of the toner can be maintained.

Typical methods, such as a pulverization method, or polymerization method may be employed for manufacturing the toner of the present invention. However, in a case of employing a pulverization method for manufacturing a toner where the SF-1 is 105 to 130, the toner is easy to manufacture by using a mechanical pulverizing machine such as turbo mill, or kryptron. Alternatively, after being pulverized, the toner may be formed into a round shape by agitating with a mixer, or by applying heat thereto.

Meanwhile, a suspension polymerization method or an emulsion polymerization method, for example, may be used as the polymerization method.

The toner of the present invention may have wax included therein. In this case, the dispersion diameter of the wax inside the toner, is to be 2 μm or less (preferably 1 μm or less, more preferably 0.5 μm) Accordingly, even in a case where silica with a large particle diameter is added, sufficient fixability can be attained. Furthermore, the wax serves as a releasing agent during toner fixation by oozing out to prevent hot offset. The wax may also reduce adherence between toners, improve transferability and transfer rate, and prevent problems such as blanks at a text portion.

By employing the dual component developing system including at least the toner and a carrier formed of a magnetic particle, the following developing properties may be obtained, in which the properties are: a suitable balance with respect to the carrier; a low stress variability as a developer; a sufficient bulk density; an excellent initial chargeability; and a stable chargeability relative to environment. Furthermore, the developing system also provides excellent controllability of toner density with a bulk density sensor or the like.

Furthermore, with an image forming apparatus applied with the present invention, a toner image(s) is formed by using a developer composed of a plurality of colors to develop an electrostatic image divided into a plurality of colors formed on an electrostatic latent image carrying body, then, a transfer unit contacts upon the surface of the electrostatic latent image carrying body having a transfer medium disposed therebetween, and then, the toner image(s) is electrostatically transferred to the transfer medium at a single time or numerous times. As a result, little transfer difficulty during the transfer process was caused, and more particularly, excellent reproduction of colors has been achieved. Accordingly, the image forming apparatus can form images with high quality.

In a case of employing the developer of the present invention to an image forming apparatus where the image forming apparatus firstly transfers a toner image formed on an electrostatic image carrying body to an intermediary transfer body, and secondly transfers the toner image to a transfer medium, high quality images having excellent thin line reproduction and satisfactory transferability with no creation of blanks can be provided when the intermediary transfer body is a flexible intermediary belt having a hardness (HS) (JIS-A) of 10° to 65°. Depending on the thickness of the layer of the belt, modification for obtaining optimum hardness is required. Molding of the belt with precise measurement is extremely difficult in a case where hardness is below 10°. This due to the fact the belt is liable to be subject to contraction and expansion during molding. A method of including an oil component to a base material is typically used for making the belt flexible. The belt employed with this method, however, has a problem of causing the oil component to exude when consecutively operated in a pressured state. This stains the photoconductor contacting to the surface of the intermediary transfer body, and creates unevenness in a lateral direction. The surface layer is typically provided for enhancing releasing property. Nevertheless, in order to prevent the exuding of oil components, the surface layer is required to have other additional qualities, such as endurance. This makes selection of materials and attainment of suitable properties difficult. Meanwhile, in a case where hardness is over 65°, molding can be achieved with more precision as hardness is increased. Furthermore, since no or little oil is required to be included in this case, staining of the photoconductor can be reduced. Nevertheless, transfer problems such as creation of blanks are not solved, and the belt is difficult to be tensely attached to rollers.

Furthermore, by using an intermediary transfer body with a static friction coefficient of 0.1 to 0.6 (more preferably 0.3 to 0.5), the toner and intermediary transfer body are able to smoothly slide against each other. Furthermore, transferability is enhanced, background stains, toner refuse, and consumption of toner are reduced.

Furthermore, excellent reproduction of colors, excellent transferability during a transfer process, and creation of high quality images can be achieved in a case where the image forming apparatus is a plural color image forming apparatus having a developing blade for regulating the layer thickness of a developing roll and that of a developer applied thereto, wherein an electrostatic images formed on an electrostatic image carrying body and divided into plural colors are developed by a developer, respectively, a transfer unit then contacts against the surface of the electrostatic image carrying body having a transfer medium disposed therebetween, and then, toner images are electrostatically transferred in sequence.

Furthermore, high speed printing, applicability to transfer media of various material (e.g. OHP, thick paper, coated paper), excellent transferability during a transfer process, and creation of high quality images can be achieved in a case where the image forming apparatus is tandem type color image forming apparatus, wherein images formed from plural image forming units arranged along a transfer belt tensioned by a drive belt roller and a sub belt roller are transferred sequentially and overlappingly on a single transfer medium conveyed by a transfer belt, thereby forming a color image on the transfer medium.

The present invention shall hereinafter be described in more detail. Any external additive, toner, manufacturing method for a developer, material for a developer, or an electrophotographic process which is known may also be applied to the present invention if required conditions are met.

(Inorganic Fine Particle)

The inorganic fine particle used for the present invention may an inorganic fine particle obtained from a typically known manufacturing method. The primary particle diameter of the inorganic fine particle is 30 nm to 160 nm, and more preferably, 50 nm to 130 nm. The primary particle diameter in this case is an average of several particle diameters. The particle diameter of the inorganic fine particle used for the present invention can be measured with a particle diameter distribution measuring apparatus with use of dynamic light scattering (e.g. DLS-700 of Ohtsuka Electronics Co. Ltd., Coulter N4 of Coulter Electronics Ltd.). In a case where the inorganic particle is a hydrophobic processed particle, it is difficult to separate secondary cohesion. Therefore, the particle diameter, in this case, should be directly obtained by photographs obtained from a scanning electron microscope, or a transmission electron microscope. In this case, 300 oxide fine particles are to be observed, and the average diameter length thereof are to be obtained.

As for a spherical hydrophobic silica, the silica fine particle proposed in Japanese laid-open publication No. 2-188421, or the silica fine particle proposed in Japanese laid-open publication No. 2000-330328 may be employed. The degree of roundness therof is no less than 0.95 and no more than 0.996 (more preferably no less than 0.98 and no more than 0.996), which results to a shape substantially of a sphere). The degree of roundness can be measured with various methods. For example, the degree of roundness may be obtained by using an image processing software for statistically analyzing photographs obtained from a scanning electron microscope, or a transmission electron microscope, and then, by obtaining an arithmetic mean of degree of roundness according to the following formula. In a case where a scanning electron microscope is used, it is preferable, for example, to form a thin deposit layer of approximately 1 nm or to measure the degree of roundness in an undeposited state using a field emission electron microscope with ultra resolution (e.g. S-5200 of Hitachi Ltd.). This is due to the fact that there is a possibility that the original shape may deform from deposition, for example, platinum deposition.

Degree of roundness=peripheral length of proportional circle/peripheral length of projected particle image

In the above equation, “peripheral length of projected particle image” means the length of an outlined portion obtained by connecting edge points of a binarized particle image, “peripheral length of proportional circle” means the outer peripheral length of a circle having an area equal as that of the binarized particle image. In a case where the average degree of roundness of the silica particle is below 0.95, fluidity of toner, supply property of toner, and preservation property of toner shall decrease. In a case where the average degree of roundness of the silica particle is above 0.996, retaining of the silica particles on the toner surface shall become difficult, affinity between the silica particles and the toner shall decrease, the silica particles shall be unable to function as external additives, storing property and chargeability with respect to environment shall deteriorate, to thereby affecting the image.

(External Additive)

Besides using the aforementioned inorganic fine particle as an external additive, other typical hydrophobic processed inorganic particles may be used in combination. In this case, it is preferable for the hydrophobic processed inorganic particles to have a primary particle with an average particle diameter of 1 to 100 nm (more preferably, 5 nm to 70 nm), and a BET ratio surface area of 20 to 500 m²/g.

Other conventional external additives may also be used, for example, silica fine particle, hydrophobic silica, metal salts of fatty acids (e.g. lead stearate, aluminum stearate), metal oxides (titania, alumina, tin oxide, antimony oxide), or fluoropolymer.

Particularly, hydrophobic silica, titania, titanium oxide, and alumina fine particle are preferable external additives. As for silica fine particles, there are, for example, HDK H 2000, HDK H 2000/4, HDK H 2050EP, HVK 21, HDK H1303 provided by Clariant K. K. Japan, and R972, RX200, RY200, R202, R805, R812 provided by Nippon Aerosil Co. Ltd. As for titania fine particles, there are, for example, P-25 provided by Nippon Aerosil Co. Ltd., STT-30, STT-65C-S provided by Titan Kogyo K. K., TAF-140 provided by Fuji Titanium Industry Co. Ltd., and MT-150W, MT-500B, MT-600B, MT-150A provided by Tayca Co. Ltd. As for titanium oxide fine particles subject to hydrophobic processing, there are, for example, T-805 provided by Nippon Aerosil Co. Ltd., STT-30A, STT-65S-S provided by Titan Kogyo K. K., TAF-500T, TAF-1500T provided by Fuji Titanium Industry Co. Ltd., MT-100S, MT-100T provided by Tayca Co. Ltd, and IT-S provided by Ishihara Sangyo Co. Ltd.

Inorganic fine particles subject to hydrophobic processing (particularly, silica fine particles, titania fine particles, and alumina fine particles) may be obtained by processing a hydrophilic fine particle with a silane coupling agent such as, methyltrimethoxysilane, methyltriethoxisilane, or octyltrimethoxysilane. An oxide fine particle processed with silicone oil, which is provided by contacting a silicone oil (applied with heat when necessary) to an inorganic fine particle, may also be preferably used.

As for a silicone oil, there are, for example, dimethly silicone oil, methyl methylphenyl silicone oil, chlorphenyl silicone oil, methylhydrogen silicone oil, alkyl-modified silicone oil, fluoro-modified silicone oil, polyether-modified silicone oil, alcohol-modified silicone oil, amino-modified silicone oil, epoxy-modified silicone oil, epoxypolyether-modified silicone oil, phenol-modified silicone oil, carboxyl-modified silicone oil, mercapto-modified silicone oil, acryl-modified silicone oil, methacryl-modified silicone oil, and α-methylstyrene-modified silicone oil.

As for an inorganic fine particle, there are, for example, silica, alumina, titanium oxide, barium titanate, magnesium titanate, calcium titanate, strontium titanate, iron oxide, copper oxide, zinc oxide, tin oxide, silex, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. Among the inorganic particles, silica and titanium are preferable. The adding amount relative to the toner is 0.1 percent to 5 percent in weight (preferably 0.3 percent to 3 percent in weight). The average particle diameter of the primary particle of the inorganic particle is no more than 100 nm (preferably no less than 3 nm and no more than 70 nm). When the average particle diameter of the primary particle of the inorganic particle is below such range, the inorganic fine particle becomes buried into the toner, and thereby cannot function effectively. When the average particle diameter of the primary particle of the inorganic particle is above such range, the surface of the photoconductor becomes damaged.

(Surface Processing Agent)

As for a surface processing agent of an external additive including inorganic fine particles, there are, for example, silane coupling agents (e.g. silane dialkyldihalide, silane trialkylhalide, silane alkyltrihalide, hexaalkyldisilazane), silinization agents, silane coupling agents including alkyl group fluoride, organic titanate coupling agents, aluminum coupling agents, silicone oil, and silicone varnish. More particularly, a surface processing agent of organic silicon combination (hydrophobic processing agent) is preferable.

(Softening Point, Discharge Start Temperature)

The softening point of the toner of the present invention is the measured softening temperature (discharge starting temperature) measured with a softening point apparatus (FP90 manufactured Mettler Inc.) by under a heating rate of 1° C./min.

(Glass Transition Temperature (Tg))

The glass transition temperature was measured with the below differential scanning calorimeter under the following conditions.

(i) differential scanning calorimeter:

SEIKO 1DSC100

SEIKO 1SSC5040 (Disk Station)

(ii) measuring condition:

temperature range; 25° C. to 150° C.

heating rate; 10° C./min

sampling time; 0.5 sec.

sample amount; 10 mg

(Molecular Weight)

A GPC method (Gel Permeation Chromatography) for measuring the number average molecular weight (Mn), the weight average molecular weight (Mw), and the peak molecular weight (Mp) of the resin contained in the toner was performed as follows.

A sample toner of 80 mg was dissolved with THF (tetrahydrofuran) to prepare a sample liquid, the sample liquid was filtrated with a filter of 5 μm, 100 μm of the sample liquid was injected into a column, and then, retention time was measured under the following conditions. In addition, polystyrene (in which the average molecular weight thereof was already obtained) was employed as a standard material, and the retention time thereof was measured, and a calibration curve was prepared, to thereby obtain a number average molecular weight of the sample liquid from conversion with respect to the polystyrene.

(i) column: guard column+GLR400M+GLR400M+GLR 400

(all columns manufactured by Hitachi Ltd)

(ii) column temperature: 40° C.

(iii) mobile phase (flow rate): THF (1 ml/min)

(iv) Peak detection: UV (254 nm)

(Penetration, Resistance and Preservation Against Heat)

Toners of 10 g each was placed into a glass container of 20 cc, was kept standing for five hours in a heating cisterna, to thereby measure penetration with a penetrometer.

(Static Friction Coefficient)

The static friction coefficient of the intermediary transfer medium of the present invention was obtained as follows.

A portable static friction meter (Heidon Tribo-gear Muse Type 94i200 manufactured by Shinto Kagaku K. K.) was used. With this static friction meter, a pressure plate was disposed at an inner peripheral of the belt so that the photoconductor belt and intermediary transfer body may contact uniformly against a flat penetrator of the static friction meter. As alternatives for the photoconductor belt and the intermediary transfer body, drum shaped members may be used. In this case, the contact area may become smaller, and data may become slightly more variable. Nevertheless, this shall have no effect in making the aforementioned contact uniform.

Static friction coefficient was obtained by measuring the maximum friction force between the flat penetrator disposed at a lower portion of the static friction meter and the belt to derive a ratio of the pressing force against each other in a perpendicular direction. Furthermore, the flat penetrator was a metal probe of φ40 with a light-weight property of approximately 40 gf, which serves to prevent, for example, damaging of the belt surface. Further, static friction coefficient was measured by disposing a buffering member between the flat penetrator and the belt. In this case, a thin cloth was employed as the buffering member.

The intermediary transfer medium (or the photoconductor belt) changes form in accordance with surface roughness and softness of material. Furthermore, since the toner is a powder material, the toner, relative to the concavo-convex surface of the belt, adheres to the bottom of a concavo portion of the belt surface. Accordingly, the static friction coefficient of the belt surface, which represents the adherence between the toner and the belt, is required to be of a measured value inclusive of the concavo portion. Therefore, the material employed for the buffering member is pliable with respect to the concavo-convex surface and does not damage a contacting member. Thereby, pressure may be applied evenly to the belt, and a precise static friction coefficient may be obtained. The fascicle of the cloth has a thickness of approximately 0.5 mmm, and a fiber thereof is approximately 5 μm to 30 μm. This allows the fiber to suitably change shape when pressed between the flat penetrator and the belt, or to gradually change shape. Thereby, pressure may be evenly applied to the belt.

Besides measuring the static friction coefficient with the static friction meter, static friction coefficient may be obtained by measuring the angleθ where a penetrator begins to slide downwards when a plane is tilted, and obtaining the static friction coefficient according to μ=θ (as shown in Japanese laid-open publication No. 8-211757). In the publication, the sliding resistance between a polyethyleneterephthalate (PET) sheet and a sample sheet is measured in a case where the PET sheet is wound around a flat penetrator (defined by ASTM D-1894 of HEIDON-14DR manufactured by Shinto Kagaku K. K.), a perpendicular load of 200 gf is applied between a targeted measurement object and the flat penetrator, and the sample sheet is horizontally moved at a speed of 100 mm/min. Nevertheless, in such case where an extensible resin material as the PET sheet is used with the penetrator, the state where the toner adheres in relative to the concavo-convex surface of the belt surface cannot be created. Therefore, only the friction force at the convex surface can be measured. Furthermore, since this measuring method prepares the sample sheet by cutting out a targeted measurement object, that is, requires a step of breaking up the targeted measurement object for performing the test, evaluation cannot be performed at anytime during real-time operation. Therefore, the portable static friction meter is desirable.

(Average Particle Diameter of Dispersed Wax)

The average particle diameter of dispersed wax according to the present invention can be analyzed by observing an ultra thin segment of toner with use of a TEM (Transmission Electron Microscope). When necessary, the average particle diameter is obtained by incorporating a TEM image into a computer, and processing the image with an image processing software. Besides the TEM, an optic microscope, a CCD camera, or a laser microscope, for example, may also be used, as long as the average particle diameter can be measured.

(Binder Resin)

Various conventional binder resins for a toner may be employed as the binder resin for the toner of the present invention, such as styrene or a polymer substitute thereof (e.g. polystyrene, poly(p-chlorostyrene, polyvinyltoluene), styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-chloromethyl methacrylate copolymer, styrene-acrylonitrile copolymer, styrene-vinylmethylketone copolymer, styrene-butadiene copolymer, styrene-isoprene copolymer, styrene-acrylonitrile-indene copolymer, styrene-maleic acid copolymer, styrene-maleate copolymer, and other styrene copolymers, polymethylmethacrylate, polybutylmethacrylate, polyvinyl chloride, polyvinyl acetate, polyethylene, polypropylene, polyester, epoxy resin, polyor resin, polyurethane, polyamide, polyvinylbutyral, polyacrylate resin, rosin, modified rosin, terpene resin, aliphatic or alycyclic hydrogen carbon resin, aromatic petroleum resin, chloriniated paraffin, paraffin wax, in which the foregoing resin materials may be employed independently or in combination. Polyester resin and polyor resin are particularly preferable.

Although various types may be used as the polyester resin, the polyester resin is preferably composed of component\mathring{1} and component\mathring{2} described below.

\mathring{1} At least one of divalent carbonxylic acid, and lower alkylester, and anhydride thereof.

\mathring{2} a diol component represented by general equation

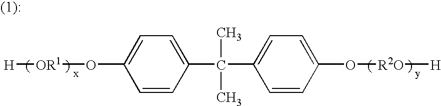

wherein x and y indicate 0 or a value no less than 1, and the typical upper limit thereof is approximately 10.)

As examples of the diol component described with general formula (1) above, there are polyoxypropylene-(n)-polyoxyethylene-(n′)-2, 2-bis(4- hydroxyphenyl)propane, polyoxypropylene-(n)-2, 2-bis(4-hydroxyphenyl)propane, and polyoxyethylene-(n)-2,2-bis(4-hydroxyphenyl)propane. More preferable examples of the dior component are polyoxypropylene-(n)-2, 2-bis(4-hydroxyphenyl)propane which satisfies 2.1≦n≦2.5, and polyoxyethylene-(n)-2,2-bis(4-hydroxyphenyl)propane which satisfies 2.0≦n≦2.5. The aforementioned dior component improves glass transition temperature, and enables easier control of reaction.

It is to be noted that aliphatic dior such as ethyleneglycol, diethyleneglycol, 1,2-butanediol, 1,3-butanediol, 1,4-butanediol,neopenthylglycol, and propyleneglycol, may also be used as the dior component.

Besides the components \mathring{1} and \mathring{2}, the polyester resin may also include a component\mathring{3} such as a carboxylic acid component that is trivalent or more, or a polyalcohol component that is trivalent or more.

As examples of the polyvalent carbonxylic acid that is trivalent or more, and lower alkylester, and anhydride thereof, there are 1,2,4-benzenetricarboxylic acid (trimellitic acid), 1,3,5-benzenetricarboxylic acid, 1,2,4-cyclohexanetricarboxylic acid, 2,5,7-naphthalenetricarboxylic acid, 1,2,4-butanetricarboxylic acid, 1,2,5-hexatricarboxylic acid, 1,3-dicarboxyl-2-methyl-2-methylenecarboxypropane, tetra(methylenecarboxy)methane, 1,2,7,8-ocatanetetracarboxylic acid, Enpoltrimer acid, and monomethyl, monoethyl, dimethyl, diethylester thereof.

As examples of the polyalcohol component that is trivalent or more, there are sorbitol, 1,2,3,6-hexantetlol, 1,4-sorbitane, pentaerythritol, dipentaerythritol, tripentaerythritol, sucrose,1,2,4-butanetriol, 1,2,5-pentatriol, glycerol, diglycerol, 2-methylpropanetriol, 2-methyl-1,2,4-butanetriol, trimethylolethane, trimethylolpropane, 1,3,5-trihydroxymethylbenzene.

The suitable compound percentage of the polyvalent monomer component that is trivalent or more is 1 mol % to 30 mol % with respect to the entire monomer composition. In a case where the percentage is below 1 mol %, the offset resistance of the toner deteriorates, and the endurance thereof has a tendency of becoming lower. In a case where the percentage is over 30 mol %, the fixability of the toner has a tendency of becoming lower.

Among the polyvalent monomer components that are trivalent or more, benzenetricarboxylic acid and also an anhydride thereof, or benzenetricarboxylic acid class such as ester are particularly preferable. That is, by employing a benzenetricarboxylic acid class, fixability and offset resistance can become balanced.

Besides the polyester resins, polyol resin may also be suitably employed as the toner binder for the present invention.

In a case where the polyester resin or polyol resin has high crosslinking density, transparency and gloss property become difficult to obtain. Therefore, it is preferable for the polyester resin or polyol resin to have no crosslink or to have low crosslink (where insoluble matter of THF is 5% or less).

The manufacturing method of the binder resins is not to be limited. Methods such as bulk polymerization, solution polymerization, emulsion polymerization, or suspension polymerization may be employed.

(Colorant (Coloring Agent))

Various conventional dyes and pigments may be used as the colorant of the toner of the present invention, such as Carbon black, Nigrosine dye, Iron black, Naphthol yellow S, Hansa yellow (10G, 5G, G), Cadmium yellow, Yellow iron oxide, Yellow ochre, Titanium yellow, Oil yellow, Hansa yellow (GR,A, RN, R), Pigment yellow L, Benzine yellow (G, GR), Permanent yellow (NCG), Vulcan fast yellow (5G,R), Tartrazine lake, Quinoline yellow lake, Anthragen yellow-BGL, Isoindoline yellow, Red iron oxide, Red lead, Vermilion lead, Cadmium red, Cadmium mercury red, Antimony vermilion, Permanent red 4R, Para red, Fire red, Parachloroorthonitroaniline red, Lithol fast scarlet G, Brilliant fast scarlet, Brilliant carmine BS, Permanent red (F2R, F4R, FRL, FRLL, F4RH), Fast scarlet VD, Vulcan fast rubine B, Brilliant scarlet G, Lithol rubine GX, Permanent red F5R, Brilliant carmine 6B, Pigment scarlet 3B, Bordeaux 5B, Toluidine maroon, Permanent bordeaux F2K, Helio bordeaux BL, Bordeaux 10B, BON maroon light, BON maroon medium, Eosin lake, Rhodamine lake B, Rhodamine lake Y, Alizarin lake, Thioindigo red B. Thioindigo maroon, Oil red, Quinacridone red, Pyrazolone red, Chromium vermilion, Benzine orange, Perinone orange, Oil orange, Cobalt blue, Cerulean blue, Alkali blue lake, Peacock blue lake, Victoria blue lake, Metal-free phthalocyanine blue, Fast sky blue, Indanthrone blue (RS, BC), Indigo, Ultramarine blue, Prussian blue, Anthraquinone blue, Fast violet B, Methylviolet lake, Cobalt violet, Manganese violet, Dioxazine violet, Anthraquinone violet, Chromium green, Zinc green, Chromium oxide, Viridian emerald green, Pigment green B, Naphthol green B, Green gold, Acid green lake, Malachite green lake, Phthalocyanine green, Anthraquinone green, Titanium oxide, Zinc oxide, Lithopone and mixtures thereof. The used amount of the colorant is 0.1 to 50 parts by weight with respect to 100 parts by weight of binder resin.

(Masterbatch Pigment)

In means to enhance the affinity between resin and pigment, a masterbatch pigment may be employed in the present invention, in which the masterbatch pigment has resin and pigment mixed or kneaded into a weight ratio of approximately 1 to 1. More preferably, a resin which is soluble in a low polarity solvent and a pigment are heated and kneaded without use of an organic solvent, to thereby provide a masterbatch pigment having excellent charge stability relative to the environment thereof. Further, dispersibility can be enhanced by using a dry powder pigment and wetting the pigment and the resin with water. Generally, organic pigments have a hydrophobic property. However, since the pigment is subject to a water cleansing step and a drying step during in the manufacture process, it is possible for a pigment condensate to be impregnated with water when a relative amount of force is applied thereto. A mixture of resin and the pigment having water impregenated therein is kneaded inside an open type kneading machine under a temperature of 100° C. or more. As a result, the water inside the pigment condensate expands upon reaching boiling point, to thereby create a force to disperse the pigment condensate from within. The force from within allows the pigment condensate to be disperse more efficiently compared to applying external force thereto. Meanwhile, since the resin is heated to a temperature which is no less than the softening point, viscosity becomes lower, the pigment condensate can be moistened effectively, and a so-called flushing effect may be obtained with the water inside the pigment condensate. Thereby, a masterbatch pigment having pigments dispersed almost into primary particles may be obtained. Furthermore, in vaporizing the water where vaporization heat is taken away from the kneaded material, the kneaded material is able to retain a relatively low temperature of 100° C. or less and a high viscosity. Thereby, shearing stress may be effectively applied to the pigment condensate. Besides using an open type kneading machine, typically, with two or three rolls for manufacturing the masterbatch pigment, a Banbery mixer of an open type or a consecutive two roller type kneading machine manufactured by Mitsui Mining Material Co. Ltd. may also be used.

(Charge Control Agent)

The toner of the present invention may also include a charge control agent when necessary. Any conventional charge control agent may be used, for example, nigrosine dye, triphenylmethane dye, chromium containing metal complex dye, molybdic acid chelate pigment, rhodamine dye, alkoxy amine, quaternary ammonium salt (including fluoro modified quaternary ammonium salt), alkyl amide, phosphorous or a compound thereof, tungsten or a compound thereof, fluoro activating agent, salicylic metallic salt, and salicylic derivative of metallic salt. More particularly, the following may be used: Bontron 03 being a nigrosine dye, Bontron P-51 being a quaternary ammonium salt, Bontron S-34 being a metal containing azo dye, E-82 being an oxynaphthoic acid metal complex, E-84 being a salicylic metallic complex, E-89 being a phenol condensate (which are manufactured by Orient Chemical Industries); TP-302 being a quaternary ammonium salt molybdenum complex, TP-415 (which are manufactured by Hodogaya Chemical Industries); Copy charge PSY VP2038 being a quaternary ammonium salt, Copy blue PR being a triphenylmethane derivative, Copy charge NEG VP2036 being a quaternary ammonium salt and Copy charge NX VP434 (which are manufactured by Hoechst AG); LRA-901, LR-147 being a Boron complex (manufactured by Japan Carlit Co. Ltd.); copper phthalocyanine, perylene, quinacridone, azo pigments; and other high molecular compounds with a functional group such as sulfonic acid group, carboxyl group, quaternary ammonium salt. The amount of the charge control agent of the present invention is not to be limited to a particular amount, but is to be variably determined according to the manufacturing method of the toner including factors such as the type of binder resin, use of additives (if necessary), or the dispersing method. It is preferable for the amount to range from 0.1 to 10 by weight with respect to the binder resin of 100 by weight. It is more preferably for the amount to range from 2 to 5 by weight. In a case where the amount is over 10 by weight, excess toner chargeability is caused, the effect of the charge control agent is reduced, and the electrostatic absorption with the developer roller is increased. Accordingly, fluidity of the developer and the density of the image are reduced.

(Carrier)

In a case where the toner of the present invention is used for a dual component developer, the toner may be mixed with a magnetic carrier, in which the ratio between the carrier and the toner contained in the developer are 100 of carrier by weight and 1 to 10 of toner by weight. Conventional magnetic carriers may be used such as iron powder, ferrite powder, magnetite powder, magnetic resin carrier having a particle diameter of 20 to 200 μm, respectively. As for coating materials, there are, for example, amino based resins, such as urea-formaldehyde resin, melamine resin, benzoguanamine resin, urea. resin, polyamide resin, and epoxy resin. Furthermore, there are also, for example, polyvinyl based resins or polyvinylidene based resins such as acryl resin, polymethylmethacrylate resin, polyacrylonitrile resin, polyvinylacetate resin, polyvinyl alcohol resin, polyvinyl butyral resin, polystyrene based resins (e.g. polystyrene resin, styrene acryl copolymer resin), olefin halide resin (e.g. poly vinyl chloride resin), polyethylene resin, polyvinyl fluoride resin, polyvinylidene fluoride resin, polyhexafluoropropylene; copolymer of vinylidene fluoride and acryl monomer, copolymer of polyvinylidene fluoride and vinyl fluoride, fluoroterpolymer such as terpolymer of tetrafluoroethylene and vinylidene fluoride and non-fluoride monomer; polyester based resins such as polyethylene terephthalate resin, polybutylene terephthalate resin; polycarbonate resin; and silicone resin. The coating film thickness of the coating materials ranges from 0.01 μm to 3 μm, and more preferably from 0.1 μm to 0.3 μm. In a case where the coating film thickness is less than 0.01, the coating film becomes difficult to control and the coating film cannot function suitably. Meanwhile, a case where the coating film thickness is more than 3 μm is unsatisfactory since conductivity cannot be obtained. A conductive powder, for example, may be included in the coating resin when necessary. As for the conductive powder, there are, for example, metallic powder, carbon black, titanium oxide, tin oxide, and zinc oxide. The average particle diameter of the conductive powder is preferably 1 μm or less. In a case where the average particle diameter of the conductive powder is more than 1 μm, electric resistance is difficult to control.

The toner of the present invention may be used as a single component type magnetic toner or non-magnetic toner using no carrier.

(Magnetic Material)

Furthermore, the toner of the present invention may have magnetic material included therein, to thereby serve as a magnetic toner. The magnetic toner may be formed by having a magnetic material fine particle contained inside a toner particle. As the magnetic material, there are, for example, metals of hard magnetism such as ferrite, magnetite, iron, nickel, cobalt, alloys thereof, compounds including such elements, alloys which have no hard magnetism element but provide hard magnetism when thermally processed such as Heusler's alloy which include manganese and copper (e.g. manganese-copper-aluminum, manganese-copper-tin), and chromium dioxide. It is preferable for the magnetic material to be contained inside the toner particle with a average particle diameter of 0.1 μm to 1 μm and thus contained in a uniform dispersed manner. Preferably, the magnetic material contained in the toner is 10 to 70 (more preferably, 20 to 50) of magnetic material by weight with respect to 100 of toner by weight.

(Wax)

In means to provide a fixing-separating property to a toner or a developer, it is preferable to have wax contained inside the toner or the developer. Furthermore, it is especially preferable to have wax contained inside the toner in a case of using an oil-free fixing unit which applies no oil to an image fixing portion. The melting point of the wax ranges from 40° C. to 120° C., more preferably from 50° C. to 110° C. In a case where the melting point of the wax is too high, fixability at low temperature may be insufficient. On the other hand, in a case where the melting point of the wax is too low, offset resistance and endurance may deteriorate. The melting point of the wax may be obtained with use of a differential scanning calorimeter (DSC). That is, the melting point is a peak melting value where a sample of few milligrams is heated at a prescribed heating rate (e.g. 10° C./min) . The amount of wax contained therein is preferably 0 to 20 by weight, and more preferably 0 to 10 by weight.

As for the wax used for the present invention, there are, for example, solid paraffin wax, micro wax, rice wax, fatty acid amide based wax, fatty acid based wax, aliphatic monoketones, fatty acid metal salt based wax, fatty acid ester based wax, partial saponificated fatty acid ester based wax, silicone wax, higher alcohol, and carnauba wax. Furthermore, polyolefin such as low molecular weight polyethylene, and polypropylene may also be used. Preferably, poly olefin or ester with a softening point of 60° C. to 150° C. (more preferably, 70° C. to 120° C.) according to environmental law.

It is more preferable to use at least one of the following waxes, which are: desorbed free fatty acid type carnauba wax with an acid value of 5 or less; montan based ester wax; oxidized rice wax with an acid value of 10 to 30; and sasol wax. The desorbed free fatty acid type carnauba wax is a desorbed free fatty acid using carnauba wax as the raw material. Accordingly, the differential scanning calorimeter has an acid value of no more than 5%, has a more crystallite property than the conventional carnauba wax, and has an average particle diameter of no more than 1 μm when dispersed inside a binding resin, thereby serving to improve dispersibility. The montan based ester wax is manufactured from a mineral. The montan based ester wax is also crystallite just as carnauba wax and has an average particle diameter of no more than 1 μm when dispersed inside a binding resin, thereby serving to improve dispersibility. It is preferable for the montan based ester wax to have an acid value of 5 to 14.

It is to be noted that the preferred dispersion diameter of the wax is 3 μm or less (more preferably, 2 μm or less, and even more preferably, 1 μm or less). Although the effluence property of the wax and the separability from a transfer medium are enhanced where the dispersion diameter of the wax is 3 μm or more, properties of the toner (e.g. resistance against high temperature and high humidity, charge stability) tends to deteriorate.

Furthermore, the oxidized rice wax is a rice bran wax which is oxidized. The preferred acid value of the oxidized rice wax is 10 to 30. In a case where the acid value is below 10, the lower limit of fixing temperature rises, and thereby causes the low temperature fixability to become insufficient. In a case where the acid value is over 30, the cold offset temperature rises, and thereby causes the low temperature fixability to become insufficient. As for the sasol wax, there are, for example, types H1, H2, A1, A2, A3, A4, A6, A7, A14, C1, C2, SPRAY 30, and SPRAY 40 (manufactured by Sasol Ltd.). Among the types, types H1, H2, SPRAY 30, and SPRAY 40 are preferred for obtaining satisfactory low temperature fixability and preservation stability. The aforementioned waxes may be used solely or in combination. The wax is 1 to 15 by weight (more preferably 2 to 10 by weight for obtaining the foregoing satisfactory results) with respect to binding resin of 100 by weight.

(Cleaning Enhancement Agent)

In order to remove the developer remaining on the photoconductor or first transfer medium after transfer, it is preferable to have a cleaning enhancement agent contained inside a toner or a developer, or applied to a surface of a toner or a developer. As for the cleaning enhancement agent, there are, for example, metal salt of fatty acid (e.g. zinc stearate, calcium stearate), and polymer fine particle manufactured by, for example, soap free emulsion polymerization of polymethylmethacrylate fine particle or polystyrene fine particle. The distribution of particle size of the polymer fine particle is relatively small, in which the volume average particle diameter is preferably 0.01 μm to 1 μm. The contained amount of cleaning enhancement agent is preferably 0.001 to 5 (more preferably 0.001 to 1 by weight).

(Manufacturing Method)

A preferred method for manufacturing the toner of the present invention includes the processes of: a process of mechanically mixing developer components including at least a binder resin, charge control agent, and a pigment; a process of melting-kneading; a process of milling; and a process of classifying. Furthermore, another manufacturing method also included is a method where powder products exclusive of particles obtained during a milling process or a classifying process are reused in a mechanical mixing process or in a melting-kneading process.

The powder products exclusive of particles obtained during a milling process or a classifying process (by-products) means fine particles or rough particles exclusive of powder products being formed with a desired particle diameter and thus being obtained during a milling process after a melting-kneading process, and also fine particles or rough particles exclusive of powder products being formed a desired particle diameter and thus being obtained during a classifying process after the milling process. The byproduct is mixed with a raw material in the mixing process or the melting-kneading process in which the preferred weight ratio of the by-product to the raw material ranges between 1 to 90 and 50 to 50.

The process of mechanically mixing the developer components including at least the binder resin, the charge control agent and the pigment has no particular restriction. The process may be performed, for example, by using a typical mixing machine with rotating wings.

After the mixing process, the mixed material is melted-kneaded with a kneading machine. A consecutive kneading machine with one or two screws, or a batch type kneading machine with a rolling mill may be used as the kneading machine. As for preferable kneading machines, there are, for example, a KTX type twin screw extruder manufactured by Kobe Steel Ltd., a TEM type extruder manufactured by Toshiba Machine Co. Ltd., a KCK twin screw extruder manufactured by KCK Engineering Co., a PCM type twin screw extruder manufactured by Ikegai K. K., and a Buss Ko-Kneader manufactured by Buss AG.

It is important to perform the melting-kneading process under suitable conditions in order to avoid breaking the molecular chain of the binder resin. More particularly, the melting-kneading temperature is to be determined according to the softening point of the binder resin. If the melting-kneading temperature is too low with respect to the softening point, the breaking of the molecular chain shall be considerable, and if the temperature is too high with respect to the softening point, dispersion shall not progress. In a case where volatile component amount in the toner is controlled, it is preferable to set the optimum conditions regarding melting-kneading temperature, time, and atmosphere while monitoring the remaining volatile component amount at that time.

After the melting-kneading process, the kneaded material is milled. In the milling process, it is preferable to first mill the kneaded material into rough particles, and then into fine particles. In this process, the kneaded material may be milled preferably by using a jet stream to allow the kneaded material to collide with a collision board, or by milling at the narrow gap located between a mechanically rotating rotor and a stator.

After the milling process, the milled material may be classified in an air stream, for example, with use of centrifugal force. Thereby accomplishing manufacture of a toner (base particle) having a prescribed particle diameter, such as a toner having volume average particle diameter of 5 μm to 20 μm. It is preferable that a volume average particle diameter of the toner is 2 μm to 8 μm by taking factors such as image quality, manufacture cost, coating rate with respect to an external additive, into consideration. The volume average particle diameter may be measured, for example, with a Coulter TA-11 meter manufactured by Coulter Electronics Inc.

The toner manufactured as described above may be modified by being added and mixed with an inorganic fine particle of the present invention such as an oxide fine particle, or a hydrophobic silica fine powder, thereby providing enhanced toner fluidity, preservability, development property, and transferability. Although an external additive may be mixed by employing a typical powder mixing machine, it is preferable, for example, to arrange a jacket for adjusting the temperature therein. The external additive could be applied in a middle of a process or in a gradual manner in a case of changing the history of the load applied to the external additive. Furthermore, factors such as rotation count, rolling speed, time, and temperature required for the mixing machine may also be changed. A strong load may first be applied to the external additive and a relatively mild load may then be applied to the external additive, or vice versa.

As for the mixing machine, there is, for example, a V-type mixer, a Rocking mixer, a Loedige mixer, a Nauta mixer, and a Henschel mixer.

Other manufacturing methods of toner are, for example, a polymerization method, and an encapsulation method. Although brief descriptions for the methods are given below, other manufacturing methods may also be employed.

\mathring{1} A polymerizable monomer (also according to necessity, a polymerization initiator, a colorant, or the like) is granulated in a aqueous dispersion catalyst.

\mathring{2} The granulated monomer compound particle is classified into a suitable particle diameter.

\mathring{3} The monomer compound particle having a prescribed particle diameter according to the classification is polymerized.

\mathring{4} After being appropriately processed where a dispersion agent is removed, the resulting polymerized product is filtered, cleansed with water, and dried, to thereby obtain a base particle.

(Encapsulation Method)

\mathring{1} A resin (also according to necessity, a colorant, or the like) is kneaded with, for example, a kneading machine, to thereby obtain a toner core material in a melted state.

\mathring{2} The toner core material is placed into water and is forcefully agitated, to thereby form the core material into a fine particle.

\mathring{3} The fine particle of the core material is placed into a shell material solution and is instilled by a poor solvent while being agitated, to thereby become encapsulated having a shell material covering the surface thereof.

\mathring{4} The resulting capsule is filtered and dried, to thereby obtain a base particle.

The toner of the present invention may be preferably manufactured with a dissolution-separation method. The method may include a method where an oily dispersant having a dissolved polyester based prepolymer containing an isocyanate group, a dispersed pigment based colorant, and a dissolved or dispersed releasing agent therein is dispersed inside an aqueous medium having fine inorganic particles and/or polymer fine particles therein; is added with a monoamine having a group containing polyamine and/or active hydrogen for creating a reaction with the prepolymer, to thereby form a urea modified polyester based resin including a urea group; and is separated from the liquid medium, to thereby leave remaining a dispersant contained with the urea modified polyester based resin (for example, described in Japanese laid-open application Nos. 11-13366,11-149180).

SF-1 (which means a shape coefficient indicating the roundness of a toner particle) and SF-2 (which means a shape coefficient indicating the convexo-concave state of a toner particle surface) with respect to a base toner of the present invention is measured in a manner described below.

It is to be noted that the term “base toner” means a toner having a component fixed by a binder resin and thus having no component added from outside such as an external additive.

For obtaining SF-1 and SF-2, 100 toner images which are enlarged in a magnification of 1000 times with a field emission electron microscope (FE-SEM) of ultra high resolution are sampled, and are calculated according to the following equations \mathring{1}and \mathring{2} by using an image analyzing apparatus (e.g. Luzex III manufactured by Nicolet Technology Instrument Corporation).

SF-1=((absolute maximum length of a toner particle)²/projection area of a toner particle)×(π/4)×100 Equation \mathring{1}

SF-2=(peripheral length of toner particle)²/(projection area of a toner)×(¼π)×100 Equation \mathring{2}

(Intermediary Transfer Body)

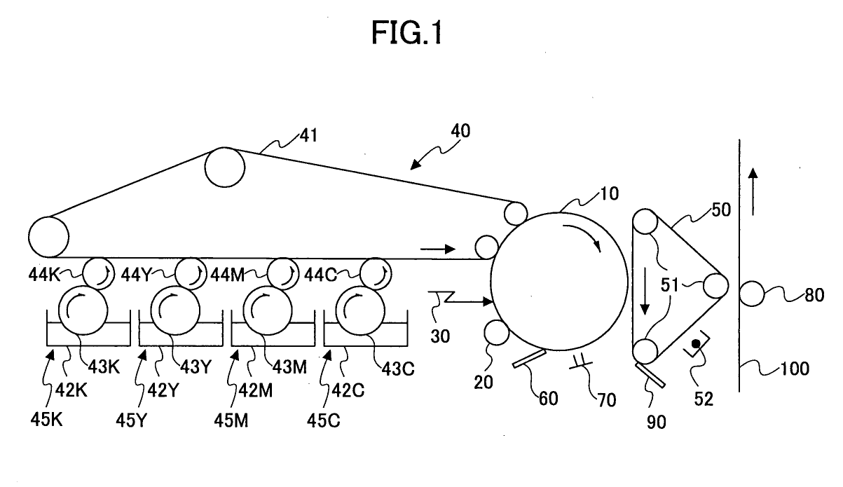

FIG. 1 is a schematic view showing a structure of an image forming apparatus (duplicating machine) of the present embodiment. A charge roller 20 serving as a charging member, an exposure member 30, a cleaning member 60 including a cleaning blade, an erase lamp 70 serving as a charge erasing member, a development apparatus 40, and an intermediary transfer body 50 serving as an intermediary transfer body are disposed around a photoconductor drum (hereinafter referred to as “photoconductor”) 10 serving as an image carrying body. The intermediary transfer body 50 is extended across by plural extension rollers 51 and is run endlessly by a driving unit (not shown) such as a motor, in a direction of the arrow in FIG. 1. Part of the extension rollers 51 also serves as a transfer bias roller for supplying a transfer bias to the intermediary transfer body 50, in which the transfer bias is supplied having a prescribed voltage from an electric source (not shown). A cleaning member 90 including a cleaning blade is disposed to the intermediary transfer body 50. A transfer roller 80 serving as a transfer member is disposed opposite of the intermediary transfer body 50, to thereby allow a developed image to be transferred to a transfer paper 100, which is a final transfer medium. The transfer roller 80 is supplied with a transfer bias by a electric source apparatus (not shown). A corona charging device 52 serving as a charging member is disposed at a periphery of the intermediary transfer body 50.

The development apparatus 40 has a development belt 41 serving as a developer carrying body. The development apparatus 40 also has a black (hereinafter referred to as “K”) development unit 45K, a yellow (hereinafter referred to as “Y”) development unit 45Y, a magenta (hereinafter referred to as “M”) development unit 45M, a cyan (hereinafter referred to as “C”) development unit 45C, which are disposed at a periphery of the development belt 41. The development belt 41 is stretched across by plural belt rollers and is run endlessly by a driving member (not shown) such as a motor in a direction of the arrow shown in FIG. 1. The development belt 41 moves almost at the same speed as the photoconductor 10 at a portion contacting against the photoconductor 10.

Since the aforementioned development units are formed having the same structure, only the K development unit 50K will be described hereinafter. The portions of the other development units 50Y, 50M, and 50C corresponding to those of the K development unit 50K shall be indicated with numerals of Y, M, and C, but descriptions thereof shall be omitted. The development unit 50K has a development tank 42K for containing a liquid developer being included with toner particles and carrier fluid components and being of high viscosity and high density, a drawing roller 43K having a lower portion thereof soaked in the liquid developer of the development tank 42K, and a coating roller 44K for forming the developer drawn up from the drawing roller 43K into a thin layer and coating the developer to the development belt 41. The coating roller 44K is conductive and is applied with a prescribed bias from an electric source (not shown).

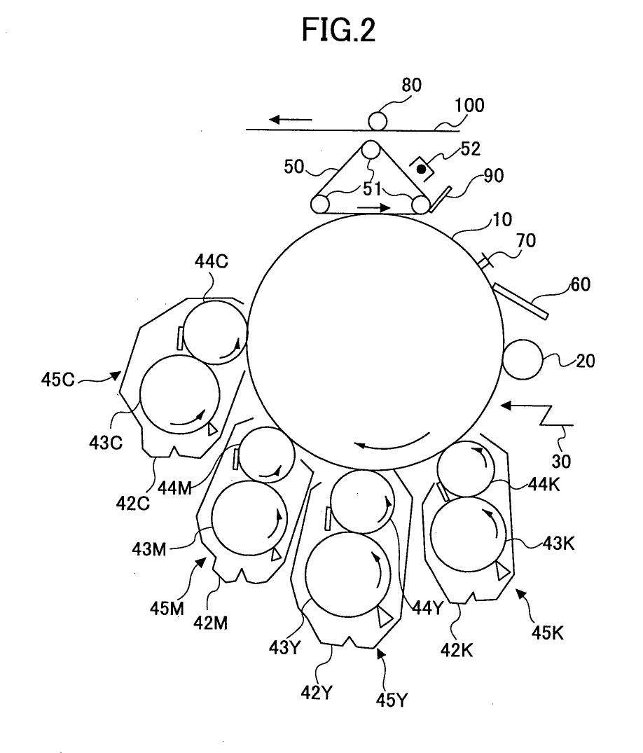

It is to be noted that any duplicating machine with a structure besides the foregoing duplicating machine of the present embodiment may also used. For example, as shown in FIG. 2, a structure where development units 45 of respective colors are disposed surrounding the photoconductor 10 may be employed.

Next, the operation of the duplicating machine of the present embodiment will be described hereinafter. With reference to FIG. 1, the photoconductor 10 is driven to rotate in the arrow direction and is uniformly charged by the charge roller 20. Then, the exposure member 30 using an optic (not shown) to forms and projects an image from the light reflected from an original document, to thereby by form an electrostatic latent image on the photoconductor 10. The electrostatic image is development by the development apparatus 40, to thereby form a toner image. The thin layer of the developer on the development belt 41 is pealed from the development belt 41 at a development area in a thin layer state upon making contact with the photoconductor 10, and is moved to a portion on the photoconductor 10 at which latent image is formed. The toner image developed by the development apparatus 40 is transferred to a surface of the intermediary transfer body 50 (first transfer) at a contacting portion (first transfer area) between the photoconductor 10 and the intermediary transfer body 50 moving almost at a same speed with the photoconductor 10. In a case of transferring three or four colors in an overlapped manner, the foregoing process is repeated, to thereby form a color image on the intermediary transfer body 50.

In order to apply charge to the overlapped on the intermediary transfer body 50, the corona charging device 52 is disposed at a downstream side of a contacting portion between the photoconductor 10 and the intermediary transfer body 50 and thus at an upstream side of a contacting portion between the intermediary transfer body 50 and the transfer medium 100 according to a rotating direction of the intermediary transfer body 50. The corona charging device 52 applies a sufficient charge to the toner image, in which the charge has a polarity same as that of the toner particles of the toner image, to thereby accomplish a satisfactory transfer to the transfer paper 100. After the toner image is charged by the corona charging device 52, a transfer bias from the transfer roller 80 causes the toner image to be transferred at once (second transfer) onto the transfer paper 100 conveyed from a sheet-feeding portion (not shown). Subsequently, the transfer paper 100 having the toner image transferred thereto is separated from the photoconductor 10 by a separating member (not shown), and is discharged from the duplicating machine after being subject to a fixing process by a fixing member (not shown). Meanwhile, residual toner remaining on the photoconductor 10 after the transfer process is removed with the cleaning member 60, and the charge remaining on the photoconductor 10 is neutralized by the erase lamp 70 in preparation for the next charge process.

As already described above, the preferable static friction coefficient of the intermediary transfer body is 0.1 to 0.6 (more preferably, 0.3 to 0.5). The preferable volume resistance is no more than few Ωcm and no less than 10³ Ωcm. By setting the volume resistance in a range between no more than few Ωcm and no less than 10³ Ωcm, the charging of the intermediary transfer body itself may be prevented. Furthermore, since the remaining charge on the intermediary transfer body may be reduced, unevenness of transfer during the second transfer may be prevented. Furthermore, transfer bias may be applied easily during the second transfer.

The material of the intermediary transfer body is not to be limited in particular, but rather any known material may be employed. Some examples will be given below. (1) One example employs a belt with a single layer formed of a material of high value according to Young modulus (elasticity), such as PC (polycarbonate), PVDF (polyvinylidene fluoride), PAT (polyalkyleneterphthalate), Blended material of PC(polycarbonate)/PAT (polyalkyleneterphthalate), Blended material of ETFE (ethylenetetrafluoroethylene copolymer)/PC (polycarbonate), Blended material of ETFE (ethylenetetrafluoroethylene copolymer)/PAT (polyalkyleneterphthalate), Blended material of PC (polycarbonate)/PAT (polyalkyleneterphthalate), and thermosetting polyimide with dispersed carbon black. The single layer belt with high value according to Young's modulus is relatively resistant to deformation from pressure during an image forming process and is able to prevent registration deviation especially during a color image forming process. (2) Another example employs the single layer belt with high value according to Young's modulus as a base layer, and further has a second layer or also a third layer as a surface layer or a intermediary layer formed on the outer periphery of the single layer. This belt having two or three layers is able to prevent creation of blanks on a line image which is a problem that a single layer belt encounters due to the hardness of the single layer belt. (3) Another example employs a belt formed of rubber and elastomer having a relatively low value according to Young's modulus, in which the belt hardly causes any blanks in a line image. Furthermore, by forming the belt with a width larger than that of a driving roller or a tension roller, a flap portion of the belt extending further than the rollers serves to prevent meandering, to thereby, require no preparation of ribs or members for preventing meandering. Therefore, manufacture cost can be saved.

Conventionally, fluorine based resin, polycarbonate resin, polyimide resin, for example, have been used for an intermediary transfer belt. In recent years, however, an elastic belt which is entirely or partly formed of an elastic material is being used. A resin belt used for transferring color images has the following problems.

Typically, color toners of four colors are used for forming color images. A toner layer comprising four layers is formed for each color image. As the toner layer is applied with pressure during a first transfer (transfer from a photoconductor to an intermediary transfer belt) and also during a second transfer (transfer from the intermediary transfer belt to a sheet), the cohesive force among toner becomes higher. The possibility in the creation of blanks in a text portion and blanks in an edge portion of a direct image become higher as the cohesive force becomes higher. The hardness of a resin belt prevents the belt from changing form in compliance to the state of the toner layer. Therefore, the belt tends to pressure the toner and cause the creation of blanks in the text portion.

In recent years, the demand to form full color images on various types of paper (e.g. Japanese paper, paper intentionally formed with a concave-convexo surface) is growing. Nevertheless, paper which lack smoothness tends to have a space created between the toner during transfer, to thereby provoke the creation of blanks during transfer. In a case where transfer pressure at a second transfer portion is increased for enhancing the bond with respect to the toner, the cohesive force in the toner layer becomes higher, to thereby create blanks at a text portion.

Meanwhile, in a case where an elastic belt is employed, the belt is able to change form at a transfer portion in compliance with a paper having an uneven surface. That is, since the elastic belt is able to change form in compliance with the concave-convex portions of the paper, there is no need to apply excess transfer pressure to the toner layer. Accordingly, a suitable bond can be obtained without creation of blanks at the text portion, and an image can be evenly transferred even to a paper having a rough surface.

One type or more of the following resins may be used as the resin of the elastic belt, in which the types are, for example, polycarbonate, fluoride based resin (ETFE, PVDF), polystyrene, chloropolystyrene, poly-α-methylstyrene, styerene-butadiene copolymer, styrene-vinylchloride copolymer, styrene-acrylate copolymer, (styrene-methyl acrylate copolymer, styrene-ethyl acrylate copolymer, styrene-butyl acrylate copolymer, styrene-octyl acrylate copolymer, styrene-phenyl acrylate copolymer), styrene-ester methacrylate copolymer (styrene-methyl methacrylate copolymer, styrene-ethyl methacrylate copolymer, styrene-phenyl methacrylate copolymer), styrene-α-chlormethylacrylate copolymer, styrene-acrylonitrile-ester acrylate copolymer, and other styrene based resins (monomer or copolymer containing styrene or substitute of styrene), methyl methacrylate resin, butyl methacrylate resin, ethyl acrylate resin, butyl acrylate resin, denatured acrylic resin (e.g. denatured acrylic silicone resin, denatured acrylic vinyl chloride resin, acryl urethane resin), vinyl chloride resin, styrene-acetic vinyl copolymer, vinyl chloride-acetic vinyl copolymer, denatured maleic rosin resin, phenol resin, epoxy resin, polyester resin, polyester polyurethane resin, polyethylene, polypropylene, polybutadiene, polyvinylidene chloride, ionomer resin, polyurethane resin, silicone resin, ketone resin, ethylene-ethylacrylate copolymer, xylene resin, polyvinyl butyral resin, polyamide resin, and denatured polyphenylene oxide. Nevertheless, the resin of the elastic belt is not to be limited to the above-given resins.

One type or more of the following materials may be used as the elastic rubber or elastomer for the elastic belt, in which the materials are, for example, butyl rubber, fluoride based rubber, acrylic rubber, EPDM rubber, NBR rubber, acrylonitrile-butadiene-styrene natural rubber, isoprene rubber, styrene-butadiene rubber, butadiene rubber, ethylene-propylene rubber, ethylene-propylene terpolymer, chloroprene rubber, chloro-sulfunated polyethylene rubber, chlorinated polyethylene, urethane rubber, syndiotactic 1,2-polybutadiene, epichlorohydrin based rubber, silicone rubber, fluoro rubber, polysulfide rubber, polynorbornene rubber, nitrile hydride rubber, and thermal plastic elastomer (e.g. polystyrene type, polyolefin type, poly vinyl chloride type, poly urethane type, poly amide type, poly urea, polyester type, fluroresin type). Nevertheless, the rubber and elastomer of the elastic belt is not to be limited to the above-given rubbers and elastomers.

The conducting agent used for adjusting resistivity is not to be limited in particular. For example, metal powder such as carbon black, graphite, aluminum, nickel, and conductive metal oxide such as tin oxide, titanium oxide, antimony oxide, indium oxide, potassium titanate, antimony tin oxide (ATO), indium tin oxide (ITO) may be used. Furthermore, the conductive metal oxide may be coated with insulating fine particles of, for example, barium sulfate, magnesium silicate, and calcium carbonate. Nevertheless, the conducting agent of the belt is not to be limited to the above-given conducting agents.

The surface layer of the belt and/or the material thereof is required to prevent an elastic material from staining the photoconductor, to reduce frictional resistance against the transfer belt surface, and to reduce adherence of toner, so that cleaning property and second transferability can be enhanced. For example, one or more types of polyurethane, polyester, epoxy resin may be used for reducing surface energy. As another example, a powder(s) or a particle(s) of one or more types or same types with different particle diameter of, for example, fluroresin, fluorinated compound, carbon fluoride, titanium oxide, silicon carbide may be used and dispersed. As another example, a fluoride based rubber material may be thermally processed to form a fluoride rich surface layer, thereby reducing surface energy.

The method for manufacturing the belt is not to be limited in particular. Some examples are: \mathring{1} a molding method using centrifugal force in which a belt is forming by flowing a material into a rotating cylindrical mold, \mathring{2} a spray coating method in which is a coat is formed by spraying of a liquid paint, \mathring{3} a dipping method in which a cylindrical mold is soaked in a solution and drawn out therefrom, \mathring{4} a casting method in which a material is casted into an outer die or inner die, or \mathring{5} a method in which a compound is wrapped to a cylindrical mold, and is then vulcanized and polished. In addition, the belt may also be manufactured by combining a plurality of methods.

As for a method for preventing the elastic belt from stretching, there is, for example, a method in which a rubber layer is formed to a core member resin layer having low stretching property, or a method in which a material for restraining the stretching property is added to a core member layer. Nevertheless, the method for manufacturing the belt is not to be limited to the aforementioned methods.

One type or more of the following fibers may be used as the material comprised in the core member layer for restraining the stretching property of the belt, in which the material is, for example, natural fiber (e.g. cotton fiber, silk fiber), synthetic fiber (e.g. polyester fiber, nylon fiber, acryl fiber, polyolefin fiber, vinylon fiber, poly vinyl chloride fiber, poly vinylidene chloride fiber, poly urethane fiber, polyacetal fiber, polyfluoroethylene fiber, phenol fiber), inorganic fiber (e.g. carbon fiber, glass fiber, boron fiber), or metal fiber (e.g. iron fiber, copper fiber). The fibers may be employed in a yarn state or in a woven fabric state.

A yarn of one or more filament may be used, and the yarn may be of any twisting type formed with any of type twisting pinning method. The yarn may also be subject to an electric conduction process.

Meanwhile, any woven fabric woven with any method may be employed, such as knitted fabric. A composite fabric as well as a fabric subject to conductive process may be used. The method for manufacturing the core member layer is not to be restricted in particular. Some examples are a method of covering a mold or the like with a tubular woven fabric and then forming a coating layer thereon, a method of forming a coating layer on one side or both sides of a core member layer by soaking a tubular woven fabric into liquid rubber or the like, or a method of winding a thread around a mold or the like in a spiral manner with a given pitch and forming a coating layer thereon.

Although the thickness of elastic layer may depend on the solidity of the elastic layer, expansion and contraction may become large to thereby form cracks if the elastic layer is too thick. Furthermore, in correspondence to a large expansion and contraction, the image may also be expand and contract if the elastic layer is too thick. Therefore, a preferred thickness is no less than 1 mm in which the upper limit is approximately 5 mm.

(Tandem Type Color Image Forming Apparatus)

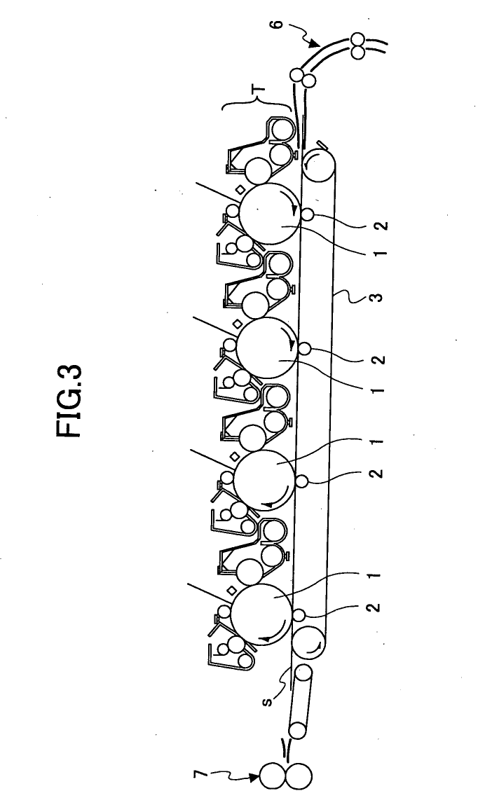

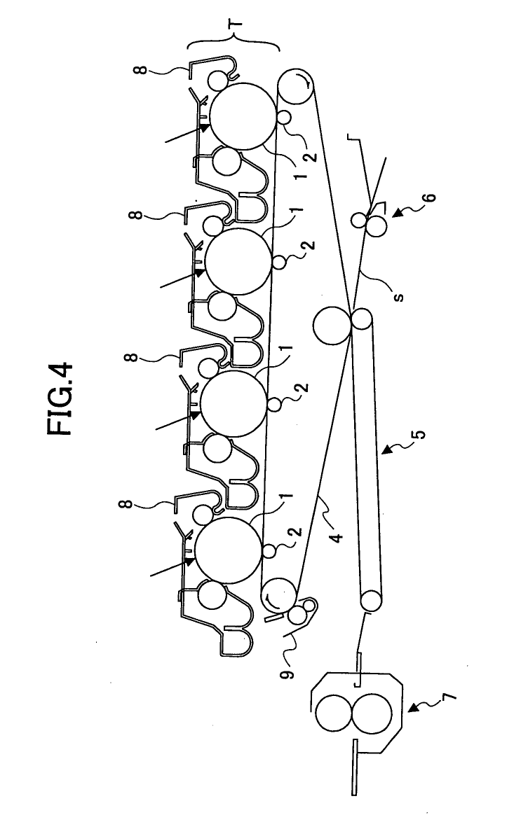

An embodiment of a tandem type color image forming apparatus of the present invention will be described hereinafter. In one example of a tandem type image forming apparatus shown with reference to FIG. 3, an image formed on each of the photoconductors 1 are transferred by a transfer unit 2, in which the images are directly transferred on to a sheet S conveyed by a sheet conveying belt 3 (direct transfer type). As another example as shown with reference to FIG. 4, an image formed on each of the photoconductors 1 is first transferred sequentially to an intermediary transfer body 4, and then a second transfer is performed by a second transfer unit 5 in which the image formed on the intermediary transfer body 4 is transferred at once to a sheet S (indirect transfer type). Although the second transfer unit 5 is illustrated as a belt structure, a roller structure may also be employed.

In comparing the direct transfer type and the indirect transfer type, the former of the types has a disadvantage in size. This is due to the fact that a sheet-feeding unit 6 is required to be disposed upstream of tandem type transfer apparatus T while a fixing unit is required to be disposed downstream thereof, thereby the apparatus tends to be formed expanding in the sheet conveying direction.

Meanwhile, with the latter of the types, the position for the second transfer may be defined relatively freely. Therefore, for example, a sheet feeding unit and a fixing unit may be disposed having a tandem type image forming apparatus T positioned thereabove so that the apparatus may be formed with a small size.

In order to avoid the expansion in the sheet conveying direction with the direct transfer type, the fixing unit 7 is required to be disposed proximate to the tandem type image forming apparatus T. Nevertheless, the fixing unit 7 cannot be disposed in a position for allowing the sheet S to flex sufficiently. Furthermore, the fixing unit 7 tends to cause difficulty in image forming at the upstream side due to factors such as, the shock created when a tip of the sheet S (especially, thick paper) advances into the fixing unit 7, or the conveyance speed difference between the speed where the sheet S is conveyed through the fixing unit 7 and the speed where the sheet S is conveyed by a transfer conveyer belt.

Meanwhile, with the indirect transfer type, the fixing unit 7 hardly causes any adverse effects upon image forming since the sheet S is able to flex sufficiently.

Therefore, among the types of tandem electrophotographic apparatuses, the indirect transfer type is recently gaining attention.

Furthermore, as shown in FIG. 4, this type-of color electrophotographic apparatus has a photoconductor cleaning unit 8 for cleaning the surface of the photoconductors 1 by removing residual transfer toner remaining on the photoconductor subsequent to the first transfer, thereby preparing for the next image forming process. The apparatus also has an intermediary transfer body cleaning unit 9 for cleaning the surface of the intermediary transfer body 4 by removing residual transfer toner remaining on the intermediary transfer member 4.

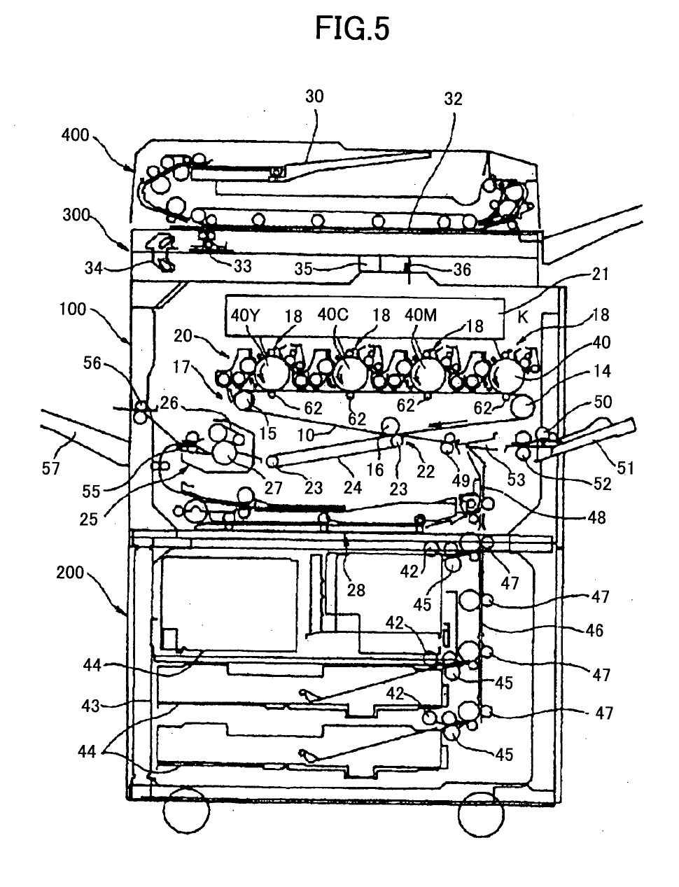

An embodiment of an indirect (tandem) type electrophotographic apparatus according to the present invention will be described with reference to FIG. 5. In FIG. 5, Numeral 100 indicates a duplicating apparatus body, numeral 200 indicates a sheet-feeding table disposed therebelow, numeral 300 indicates a scanner mounted on the duplicating apparatus body 100, and numeral 400 indicates an automatic document feeding apparatus (ADF) mounted on the scanner 300. The duplicating apparatus body 100 has an intermediary transfer body 10 disposed at a center thereof, in which the intermediary transfer body 10 is formed as an endless belt.

As shown in FIG. 5, three support rollers 14, 15, and 16 are rotated to enable rotary conveyance in a clockwise manner.

As shown in FIG. 5, an intermediary transfer body cleaning unit 17 is disposed on a left side of support roller 15 (a second support roller among the three support rollers), in which the intermediary transfer body cleaning unit 17 serves to remove residual toner remaining on the intermediary transfer body 10 after an image transfer process. Four image forming units corresponding to yellow, cyan, magenta, and black are disposed next to each other in the conveying direction on the intermediary transfer body 10 stretched between the support roller 14 (a first support roller among the three support rollers) and the second support roller 15, thereby forming a tandem image forming apparatus 20.

Furthermore, as shown in FIG. 5, an exposing unit 21 is disposed above the tandem image forming apparatus 20. Furthermore, a second transfer unit 22 is provided opposite from the tandem image forming apparatus 20 having the intermediary transfer body 10 disposed therebetween. The second transfer unit 22 has a second transfer belt 24 being formed as an endless belt and thus being stretched between a roller pair 23. The second transfer belt 24 presses against the support roller 16 (third support roller among the three support roller) having the intermediary transfer body 10 disposed therebetween, thereby transferring the image on the intermediary transfer body 10 to a sheet.

Furthermore, a fixing unit 25 is disposed next to the second transfer unit 22 for fixing the image transferred to the sheet. The fixing unit 25 includes a fixing belt 26 which is formed as an endless belt and a pressure roller 27, in which the pressure roller 27 presses against the fixing belt 26.

The second transfer unit 22 may additionally serve to convey the sheet having an image transferred thereon to the fixing unit 25. The second transfer unit 22 may also be provided with a transfer roller or a non-contact charger. This, however, may make it difficult for the second transfer unit 22 to additionally perform conveyance of a sheet.

Furthermore, a sheet flipping unit 28 is disposed below the second transfer unit 22 and the fixing unit 25, and thus parallel to the tandem image forming apparatus 20, in which the sheet flipping unit 28 serves to flip a sheet when recording images on both sides of the sheet.

In performing a duplication (copying) process with the indirect (tandem) type electrophotographic apparatus, a document may be placed on an original document table 30 of the automatic document feeding apparatus 400. Or instead, the document may be placed on a contact glass on the scanner 300 by opening the automatic document feeding apparatus 400, and fixed thereon by closing the automatic document feeding apparatus 400.

When a start switch (not shown) is pressed in a case where the document is set on the automatic document feeding apparatus 400, the scanner 300 is driven, and a first transport member 33 and a second transport member 34 begin to transport after the original document is conveyed to the contact glass 32. Meanwhile, when a start switch (not shown) is pressed in a case where the document is set directly onto the contact glass 32, the scanner 300 is driven, and a first transport member 33 and a second transport member 34 begin to transport immediately. Light is emitted from a light source of the first transport member 33 to the original document and thus reflects a light reflected from the original document surface to a direction of the second transport member 34. Then, the light is further reflected by a mirror of the second transport member 34 to a reading sensor 36 via an imaging lens 35, to thereby read the content of the original document.

Furthermore, when the start switch is pressed, a driving motor (not shown) drives and rotates one of the support rollers 14, 15, 16, by which the other remaining support rollers are rotated subordinate to the rotation of the support roller driven by the driving motor. Thereby, the intermediary transfer body 10 rotates to perform conveyance. At the same time, the photoconductor 40 of each of the image forming units 18 is rotated to form single color images of black, yellow, magenta, and/or cyan thereon. Together with the conveyance of the intermediary transfer body 10, the single color images are sequentially transferred on the intermediary transfer body 10, thereby forming a combined color image thereon.

Furthermore, when the start switch is pressed, one of the sheet-feeding rollers 42 of the sheet-feeding table 200 is selected and rotated. Accordingly, a sheet is taken out from one of the sheet-feeding cassettes 44 which are racked on a paper bank 43. Then, a separation roller 45 performs separation so that a single sheet may be conveyed to a sheet conveyance path 46. Then, a conveying roller 47 conveys the sheet to a sheet-feeding path 48 inside the duplicating apparatus body 100. Then, the sheet is stopped upon contacting against a resist roller 49. Or instead, a sheet may be taken out from a hand-feed tray 51 by rotation of a sheet-feeding roller 50. Then, a separation roller 52 performs separation so that a single sheet is conveyed to a hand-feed path 53. Then, likewise, the sheet is stopped upon contacting against a resist roller 49.

Then, the resist roller 49 rotates in correspondence to the timing of the color images on the intermediary transfer body 10. The sheet is fed in-between the intermediary transfer body 10 and the second transfer unit 22. The second transfer unit 22 performs second transfer for recording a color image to the sheet.

After the image is transferred to the sheet, the second transfer unit 22 conveys the sheet to the sheet fixing unit 25. The sheet-fixing unit 25 fixes the transferred image on the sheet by applying heat and pressure thereto. A switching nail 55 switches the direction of the sheet towards a discharge roller 56. Then, the discharge roller 56 discharges the sheet. Then, the discharged sheet is stacked onto a discharge tray 57. Or instead, the switching nail 55 may switch the direction of the sheet towards the sheet-flipping unit so that the sheet may be flipped and guided to a transferring position. Then, an image is recorded on the other side of the sheet. Then, the sheet is discharged from the discharge roller 56 to the discharge tray 57.

Meanwhile, after the image is transferred, the intermediary transfer body cleaning unit 17 removes the residual toner remaining on the intermediary transfer body 10 to prepare for a next image forming process with the tandem image forming apparatus 20.

It is to be noted that the resist roller 49 may be applied with a bias for removing dust created from the sheets (although resist roller 49 is, in general, earthed).

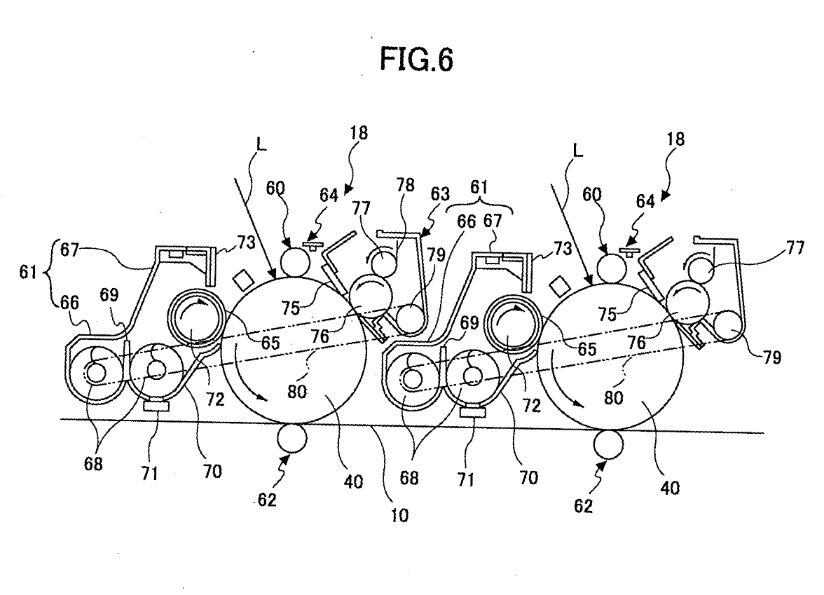

With reference to FIG. 6, the image forming units 18 of the tandem image forming apparatus 20 may have, for example, a charging unit 60, a developing unit 61, a first transfer unit 62, a photoconductor cleaning unit 63, and a charge removing unit 64 disposed in a manner surrounding the drum-shaped photoconductors 40 thereof.

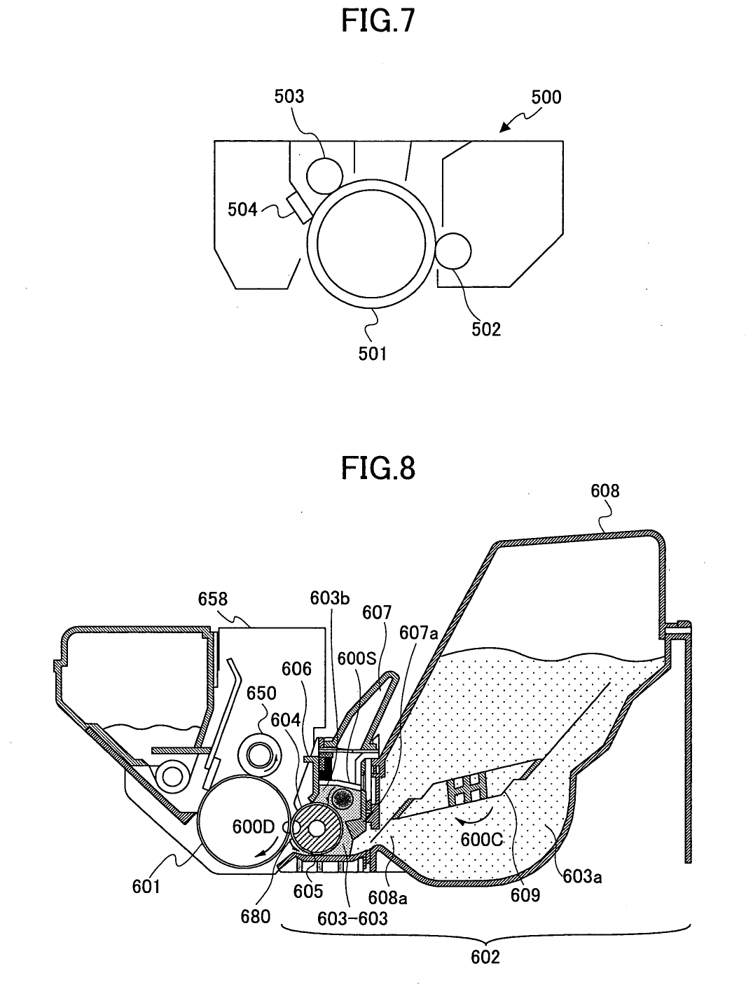

Furthermore, FIG. 7 is a schematic view showing a process cartridge including the developer of the present invention. FIG. 7 shows an entire body of a process cartridge 500 having a photoconductor 501, a development unit 502, a charge unit 503, and a cleaning unit 504. With the present invention, components, for example, the photoconductor 501, the development unit 502, the charge unit 503, and the cleaning unit 504, may be employed in various combinations to the process cartridge 500, to thereby form a united body. The process cartridge 500 may be detachably attached to an image forming apparatus body, such as a duplicating machine or a printer.

Furthermore, FIG. 8 shows another image forming apparatus having a process cartridge included with the developer of the present invention. This image forming apparatus includes a photoconductor 601 having a drum-shape, a development unit 602, resident developer 603-603, magnetic toner 603a, magnetic carrier 603b, a development sleave 604, a magnet roller 605, a doctor blade 606, a developer containment case 607, a predoctor 607a, a toner hopper 608, toner supply port 608a, an agitator unit 609, a charge roller 650, a cleaning unit 658, a magnetic field forming unit 680, a development area 600D, and a developer containing portion 600S.

With the image forming apparatus having a process cartridge included with the developer of the present invention, first, the photoconductor 601 is rotated at a prescribed speed. During the rotation of the photoconductor 601, the charge roller 650 negatively/positively charges the surface of the photoconductor 601 to provide a uniform charge. Next, the photoconductor 601 is exposed by an exposure unit with use of, for example, slit exposure method or laser beam scanning exposure method. This allows an electrostatic latent image to be form on the peripheral surface of the photoconductor 601. Then, the electrostatic latent image is developed by the development unit 602 with use of toner (developer), to thereby form a toner image. A transfer medium is conveyed from a sheet-feeding portion to a space between the photoconductor 601 and a transfer unit in correspondence to the rotation timing of the photoconductor 601, thereby the transfer unit transfers the toner image to the transfer medium. The transfer medium having an image formed thereon is separated from the photoconductor 601 and is guided to a fixing unit. The fixing unit fixes the image onto the transfer medium. Subsequently, the transfer medium is dishcharged from the image forming apparatus, to thereby provide a copy (duplicate). After the transfer, the cleaning unit 658 cleans the surface of the photoconductor by removing residual toner remaining thereon. Furthermore, charge is removed or erased from the photoconductor surface in preparation from a next image forming process.

The present invention will hereinafter be described in more detail with reference to the following embodiments and comparative examples. The employed evaluation machines, the obtained properties, and the results thereof will be described together with the use of charts. Nevertheless, it is to be noted that the present invention is not to be limited to the said embodiments. In the following description, the terms “part” and “percent” is a parameter indicating weight, unless indicated as otherwise.

(Evaluation Machines)

The images subject for evaluation were evaluated with use of one of the evaluation machines A, B, C, and D described below.

(Evaluation Machine A)

A full color laser printer (IPSiO Color 8000 manufactured by Ricoh Co.Ltd.) having a four color nonmagnetic two component type development portion and four color photoconductors was employed as evaluation machine A, in which the fixing unit thereof was modified into an oil-less fixing unit. The evaluation was performed with high speed printing (20 sheets to 50 sheets/min/A4 size paper).

(Evaluation Machine B)

A full color laser printer (IPSiO Color 8000 manufactured by Ricoh Co.Ltd.) having a four color nonmagnetic two component type development portion and four color photoconductors was employed as evaluation machine B, in which the printer was modified as an indirect transfer type and also having the fixing unit thereof modified into an oil-less fixing unit. The evaluation was performed with high speed printing (20 sheets to 50 sheets/min/A4 size paper).

(Evaluation Machine C)

A full color laser printer (IMAGIO Color 2800 manufactured by Ricoh Co.Ltd.), which uses a four color developing portion and a two component developer to develop each color to a single drum-shaped photoconductor, transfers the colors sequentially to an intermediary transfer body, and then transfers four colors at once to a transfer medium, was employed as evaluation machine C, in which the fixing unit thereof was modified to an oil-less fixing unit.

(Evaluation Machine D)

A full color laser printer (IPSiO Color 5000 manufactured by Ricoh Co.Ltd.), which uses a four color developing portion and a single component developer to develop each color to a single belt-shaped photoconductor, transfers the colors sequentially to an intermediary transfer body, and then transfers four colors at once to a transfer medium, was employed as evaluation machine D, in which the fixing unit thereof was a oil coating type fixing unit.

(Evaluation Machine E)

A full color laser printer (IPSiO Color 8000 manufactured by Ricoh Co.Ltd.), having a four color nonmagnetic two component developing portion and four color photoconductors to be used as a tandem transfer type was employed as evaluation machine E, in which the fixing unit thereof was a oil coating type fixing unit. The evaluation was performed with high speed printing (20 sheets to 50 sheets/min/A4 size paper).

(Evaluated Properties)

1) Cleaning Property

In evaluating cleaning property, a 40 mm×40 mm image with a adherence of 0.85 mg/cm2 was formed to a photoconductor, then, a duplicating machine was switched off after an untransferred image has passed a cleaning portion, then, the photoconductor was taken out from the duplicating machine, then, a transparent tape was employed to peal out a portion of the photoconductor at which the image was formed, then, the tape was adhered to a white paper, and then, a Macbeth density meter was employed to measure residual toner. A value obtained by subtracting the density when the tape was adhered to the paper was evaluated, wherein: ⊚ indicates no more than 0.02, ◯ indicates 0.03 to 0.04, Δ indicates 0.05 to 0.07, × indicates no less than 0.08.

2) Property for Burial of an External Additive

In evaluating burial of an external additive, a developer was preserved in an atmosphere of 40° C., 80% for one week, then, the developer was agitated for one hour inside a development unit, then, the toner surface was observed with a FE-SEM (S-4200 manufactured by Hitachi Ltd.) to observe the state of burial of an external additive, and then, results were grouped into four levels in an order of ×, Δ, ◯, ⊚ (where × is the most unfavorable level and ⊚ is the most favorable level). The developer is becomes more favorable as burial becomes lesser.

3) Creation of Blanks in a Text Portion of an Image

In evaluating creation of blanks in a text portion of an image, after outputting 30,000 sheets of an image chart of an image area of 50% in a single color mode, a text image was outputted in four colors to an OHP sheet (Type DX manufactured by Ricoh Co.Ltd.), and then, the frequency in the creation of blanks in a text portion of a line image due to untransferred toner was evaluated and grouped into four levels in an order of ×, Δ, ◯, ⊚ (where × is the most unfavorable level and ⊚ is the most favorable level).

4) Rate of Toner Transfer

In evaluating the rate of toner transfer, after outputting 200,000 sheets of an image chart of an image area of 7% in a single color mode, the rate of toner transfer was calculated by taking into account the relation between the employed amount of toner and the discarded amount of toner.

Transfer rate=100×(employed amount of toner-discarded amount of toner/(employed amount of toner),

wherein ⊚ indicates a transfer rate of 90 or more, ◯ indicates a transfer rate of below 90 but no less than 75, Δindicates a transfer rate of below 75 but no less than 60, and × indicates a transfer rate of below 60.

5) Transfer Dust

In evaluating creation of transfer dust, after outputting 30,000 sheets of an image chart of an image area of 50% in a single color mode, a direct image of 10 mm×10 mm was outputted in four colors to paper (Type 6000 manufactured by Ricoh Co.Ltd.), and then, the degree of transfer dust was evaluated and grouped into four levels in an order of ×, Δ, ◯, ⊚ (where × is the most unfavorable level and ⊚ is the most favorable level).

6) Background Stains

In evaluating creation of background stains, after outputting 30,000 sheets of an image chart of an image area of 50% in a single color mode, development of an image on a white paper was interrupted, then, a developer on a photoconductor after development is transferred to a tape, and then, the density of the tape was compared with that of an untransferred tape by using A 938 Spectro densitometer (manufactured by X-Rite Inc.). The results were grouped into four levels in an order of ×, Δ, ◯, ⊚ (where × is the most unfavorable level and ⊚ is the most favorable level). The background stains become lesser as difference of density becomes lesser.

7) Fixability

Fixability was evaluated taking into consideration factors such as resistance to hot offset, resistance to cold offset, and resistance to conveyance problems such as sheet jamming. The results of fixability were grouped into four levels in an order of ×, Δ, ◯, ⊚ (where × is the most unfavorable level and ⊚ is the most favorable level)

(Evaluation of a Two Component Developer)

In evaluating an image applied with a two component developer, a ferrite carrier being coated by silicone resin with an average thickness of 0.3 μm and being formed with an average particle diameter of 50 μm was used, then, 5 parts by weight of toner for each color with respect to 100 parts by weight of toner was uniformly mixed and charged with use of a Turbula mixer, and thereby the developer was formed.

(Manufacture of a Carrier)

\mathring{1} Core Material

Cu—Zn ferrite particle (weight average diameter : 35 μm 5000 parts

\mathring{2} Coating Material

Toluene 450 parts

Silicone resin SR 2400 (manufactured by Toray Dow Corning Silicone, non-volatility 50%) 450 parts

Aminosilane SH 6020 (manufactured by Toray Dow Corning Silicone) 10 parts

Carbon Black

The foregoing coating materials are dispersed inside a homomixer for ten minutes to prepare as a coating liquid. The coating liquid and the core material are disposed inside a coating apparatus, in which the coating apparatus has a rotary bottom disk and an agitation wing in a fluid bed and creates a rotary flow to thereby allow the coating liquid to be coated on the core material. The obtained coated material is disposed into an electric furnace of 250° C. and is baked for two hours. Thereby, the foregoing carrier may be obtained.

(Inorganic Fine Particle 1)

RX-50 (manufactured by Nippon Aerosil Co.Ltd.)as a hydrophobic silica with an average particle diameter of 50 nm was employed as an inorganic fine particle 1.

(Inorganic Fine Particle 2)

A titania which is Titania MT-500B with an average particle diameter of 35 nm (manufactured by Tayca Co. Ltd.) processed with HMDS was employed as an inorganic fine particle 2.

(Inorganic Fine Particle 3)

A distilled methyltrimethoxysilane was heated and nitrogen gas was bubbled thereto to gas wake the methyltrimethoxysilane with the nitrogen gas, oxyhydrogen flame burner was applied and pure water was supplied from spray nozzle, to thereby decompose by combustion in the oxyhydrogen flame. In this case, the added methyltrimethoxysilane was 1268 g/hr, the added oxygen gas was 2.8 Nm3/hr, the added hydrogen gas was 2.0 Nm3/hr, the added nitrogen gas was 0.59 Nm3/hr, the added pure water was 5.6 g/hr, and the heat competence of the particle of the spherical silica fine particle was 1.28 kcal/g. Hexamethyldisilazane was supplied at a rate of 11.2 g/hr from a spray nozzle to the created spherical silica fine particle, and then collected with a bug filter. The temperature of the hexamethyldisilazane was 300° C. The obtained silica fine particle was formed as a spherical silica having an average particle diameter of 160 nm and an average degree of roundness of 0.975.

(Inorganic Fine Particle 4)

(1) Methanol of 623.7 g, water of 41.4 g, and 28% ammonia water of 49.8 g were added and mixed into a 3 liter glass reactor having an agitator, a dropping funnel, and a thermometer. This solution was prepared under 35° C., and was dropped with tetramethoxysilane of 1163.7 g and a 5.4% ammonia water of 418.1 g while being agitated, in which the former was dropped for a period of six hours and the latter was dropped for a period of four hours. Then, agitation was continued for 0.5 hours, and hydrolyzation was performed, to thereby obtain suspension of the silica fine particle. Then, an ester adapter and a cooling tube is attached to the glass reactor, heating is performed under 60° C. to 70° C., and water of 1200 g is added when methanol of 1132 g is discarded. Then, heating is further performed under 70° C. to 90° C. to discard methanol of 273 g, to thereby obtain a aqueous suspension of silica fine particle.

(2) Methyltrimethoxysilane of 11.6 g (amounting to 0.1 in mol ratio with respect to tetramethoxysilane) was dropped to the aqueous suspension at room temperature for a period of 0.5 hours, and agitation was further performed for twelve hours after the dropping, to thereby achieve surface processing of the silica fine particle.

(3) After methylisobutylketone of 1440 g was applied to the dispersed liquid, heating was performed under 80° C. to 110° C., and methanol water was discarded in seven hours. Then, hexamethyldisilazane of 357.6 was added to the dispersed liquid under room temperature, then, heating was performed under 120° C. and reacted for three hours, and thereby, trimethylsilicized the silica fine particle. Subsequently, the solution is discarded under reduced pressure, to thereby obtain a spherical silica fine particle of 477 g having an average particle diameter of 120 nm and an average degree of roundness of 0.990.

(Polyol Resin 1)

A depolymer bisphenol A type epoxy resin (average molecular weight by number: approximately 360) of 378.4 g, a polymer bisphenol A type epoxy resin (average molecular weight by number: approximately 2700) of 86.0 g, a diglycidyl compound of a bisphenol A type propyleneoxide adduct (n+m according to the aforementioned general equation: approximately 2.1) of 191.0 g, a bisphenol F of 274.5 g, a p-coumal phenol of 70.1 g, xylene of 200 g is added to a separable flask having a agitating unit, a thermometer, a N₂ introduction port, and a cooling tube. Under a N₂ atmosphere, heating is performed to a temperature of 70° C. to 100° C., then, lithium chloride is added, and then, water and xylene are bubbled. Thereby removing water, xylene, other volatile components, and components soluble with a polar solvent. Then, polymerization is performed under a reaction temperature of 180° C. for 6 to 9 hours, thereby obtaining a polyol resin (polyol resin 1) of 1000 g having a number average molecular weight (Mn) of 3800, a weight average molecular weight (Mw)/number average molecular weight (Mn) of 3.9, a peak molecular weight (Mp) of 5000, softening point of 109° C., a glass transition temperature (Tg) of 58° C., epoxy amount of 20000 or more. In the polymerization reaction, the reaction conditions were controlled so that monomer components shall not remain. The main chain of polyoxyalkylene group was confirmed by NMR.

(Manufacture of Toner)

[Black Toner 1,2]

| | | |
|---|---|---|
| water | 1000 | parts |
| phthalocyanine green containing cake (solid part 30%) | 200 | parts |
| carbon black (#44 manufactured by Mitubishi Chemical | 540 | parts |
| Corp.) | | |
| polyol resin 1 | 600 | parts |

The foregoing materials was mixed with a Henschel mixer, to thereby obtain a mixture where water is impregnated in a pigment aggregate. Subsequently, the mixture was kneaded with twin rollers with a surface temperature of 100° C. for 45 minutes, then, rolling and cooling are performed, and then, milling is performed with a pulverizer. Thereby, a masterbatch pigment was obtained.

| | | |
|---|---|---|
| polyol resin 1 | 95 | parts |
| above-described masterbatch | 10 | parts |
| charge control agent (Bontron E-84 manufactured by | 2 | parts |
| Orient Chemical Industries) | | |
| wax (fatty acid ester wax, melting point 83° C., | 5 | parts |
| viscosity 280 mPa · s (90° C.)) | | |

After the foregoing materials were mixed with a mixer, the mixed material was melted and kneaded by a mill with two rollers for 30 minutes, and then, the kneaded material was rolled and cooled. Subsequently, a milling machine of a jet mill type (I type mill manufactured by Nippon Pneumatic Co. Ltd.) and a classifying apparatus using wind force of a rotary flow (DS classifying apparatus manufactured by Nippon Pneumatic Co. Ltd.) were employed along with modifying manufacture conditions, to thereby obtain the black colorant particles given below.

Black toner 1→volume average particle diameter: 6.5 μm, SF-1:129, SF-2:176

Black toner 2→volume average particle diameter: 6.5 μm, SF-1:140, SF-2:185

[Black Toner 3]

After the black toner 1 was milled, a black colorant particle having a volume average particle diameter: 6.7 μm, SF-1:125, SF-2:140 was obtained by using a mechanical milling machine (Turbo mill manufactured by Turbo Kogyo Co. Ltd.) and a wind force classifying machine (Elbow jet classifier manufactured by Nittetsu Mining Co.Ltd.).

[Black Toners 4 to 6]

The black toner 1 was applied to a surfusion system (manufactured by Hosokawa Micron Co.) along with modification of manufacture conditions, to thereby obtain the black colorant particles given below.

Black color toner 4→volume average particle diameter: 6.5 μm, SF-1:106, SF-2:120

Black color toner 5→volume average particle diameter: 6.6 μm, SF-1:110, SF-2:133

Black color toner 6→volume average particle diameter: 6.7 μm, SF-1:102, SF-2:115

Next, yellow toner, magenta toner, and cyan toner were kneaded under the following conditions.

[Yellow Toner]

| | | |
|---|---|---|
| water | 600 | parts |
| pigment yellow 180 with hydrous cake (solid part 50%) | 1200 | parts |
| polyol resin 1 | 600 | parts |

The foregoing materials was mixed with a Henschel mixer, to thereby obtain a mixture where water is impregnated in a pigment aggregate. Subsequently, the mixture was kneaded with twin rollers with a surface temperature of 130° C. for 45 minutes, then, rolling and cooling are performed, and then, milling is performed with a pulverizer. Thereby, a masterbatch pigment was obtained.

| | |
|---|---|
| polyol resin 1 | 92 parts |
| above-described masterbatch | 16 parts |
| charge control agent (Bontron E-84 | 2 parts |
| manufactured by Orient Chemical Industries) | |
| wax (fatty acid ester wax, melting point 83° C., | 5 parts |
| viscosity 280 mPa · s (90° C.)) | |

After the foregoing materials were mixed with a mixer, the mixed material was melted and kneaded by a mill with two rollers for 30 minutes, and then, the kneaded material was rolled and cooled.

[Magenta Toner]

| | | |
|---|---|---|
| water | 600 | parts |
| pigment red 57 with hydrous cake (solid part 50%) | 1200 | parts |
| polyol resin 1 | 600 | parts |

The foregoing materials was mixed with a Henschel mixer, to thereby obtain a mixture where water is impregnated in a pigment aggregate. Subsequently, the mixture was kneaded with twin rollers with a surface temperature of 130° C. for 45 minutes, then, rolling and cooling are performed, and then, milling is performed with a pulverizer. Thereby, a masterbatch pigment was obtained.

| | | |
|---|---|---|
| polyol resin 1 | 96 | parts |
| above-described masterbatch | 8 | parts |
| charge control agent (Bontron E-84 manufactured by | 2 | parts |
| Orient Chemical Industries) | | |
| wax (fatty acid ester wax, melting point 83° C., | 5 | parts |
| viscosity 280 mPa · s (90° C.)) | | |

After the foregoing materials were mixed with a mixer, the mixed material was melted and kneaded by a mill with two rollers for 30 minutes, and then, the kneaded material was rolled and cooled.

[Cyan Toner]

| | | |
|---|---|---|
| water | 600 | parts |
| pigment blue 15:3 with hydrous cake (solid part 50%) | 1200 | parts |
| polyol resin 1 | 600 | parts |

The foregoing materials were mixed with a Henschel mixer, to thereby obtain a mixture where water is impregnated in a pigment aggregate. Subsequently, the mixture was kneaded with twin rollers with a surface temperature of 130° C. for 45 minutes, then, rolling and cooling are performed, and then, milling is performed with a pulverizer. Thereby, a masterbatch pigment was obtained.

| | | |
|---|---|---|
| polyol resin 1 | 96 | parts |
| above-described masterbatch | 4 | parts |
| charge control agent (Bontron E-84 manufactured by | 2 | parts |
| Orient Chemical Industries) | | |
| wax (fatty acid ester wax, melting point 83° C., | 5 | parts |
| viscosity 280 mPa · s (90° C.)) | | |

After the foregoing materials were mixed with a mixer, the mixed material was melted and kneaded by a mill with two rollers for 30 minutes, and then, the kneaded material was rolled and cooled.

Similar as the black toner, the kneaded materials of yellow, magenta, and cyan with the colorant particles described in the charts below were obtained by modifying, for example, the employed milling machine and milling conditions.

| | Yellow | | |
|---|---|---|---|
| | Volume | | |
| | average | | |
| | particle | | |
| | diameter | SF-1 | SF-2 |
| Toner 1 | 6.4 | 127 | 175 |
| Toner 2 | 6.5 | 133 | 188 |
| Toner 3 | 6.5 | 121 | 144 |
| Toner 4 | 6.5 | 105 | 121 |
| Toner 5 | 6.4 | 112 | 133 |
| Toner 6 | 6.4 | 103 | 118 |

| | Magenta | | |
|---|---|---|---|
| | Volume | | |
| | average | | |
| | particle | | |
| | diameter | SF-1 | SF-2 |
| Toner 1 | 6.6 | 129 | 179 |
| Toner 2 | 6.7 | 137 | 184 |
| Toner 3 | 6.7 | 124 | 148 |
| Toner 4 | 6.5 | 108 | 125 |
| Toner 5 | 6.6 | 113 | 138 |
| Toner 6 | 6.7 | 103 | 116 |

| | Cyan | | |
|---|---|---|---|
| | Volume | | |
| | average | | |
| | particle | | |
| | diameter | SF-1 | SF-2 |
| Toner 1 | 6.3 | 128 | 177 |
| Toner 2 | 6.5 | 133 | 181 |
| Toner 3 | 6.4 | 122 | 139 |
| Toner 4 | 6.6 | 106 | 123 |
| Toner 5 | 6.5 | 111 | 136 |
| Toner 6 | 6.5 | 104 | 116 |

By adding the aforementioned inorganic fine particles 1 to 4 of 3.0 wt % to a toner (developer), mixing with a Henschel mixer, filtering with a mesh size of 50 μm, and removing aggregate material, toner for each color was obtained.

Embodiment 1

A toner (developer) having the inorganic fine particle 1 added to Toner 1 for each color was evaluated with evaluation machine A.

Embodiment 2

Other than the fact of using Toner 3 instead of Toner 1 in embodiment 1, a toner (developer) was formed and evaluated in the same manner as embodiment 1.

Embodiments 3 and 4

Other than the fact of using Toners 4,5 instead of Toner 1 in embodiment 1, toners (developers) were formed and evaluated in the same manner as embodiment 1, respectively.

### COMPARATIVE EXAMPLES 1 AND 2

Other than the fact of altering Toner 1 in embodiment 1 to Toners 2,6, toners (developers) were formed and evaluated in the same manner as embodiment 1, respectively.

Embodiment 5

A toner (developer) having the inorganic fine particle 2 added to Toner 5 for each color is evaluated with evaluation machine A.

Embodiment 6

A toner (developer) having the inorganic fine particle 3 added to Toner 5 for each color is evaluated with evaluation machine A.

Embodiment 7

A toner (developer) having the inorganic fine particle 4 added to Toner 5 for each color is evaluated with evaluation machine A.

Embodiment 8

Other than the fact of adding HDH-H2000 of 1.0 wt % (first particle diameter: 12 nm, manufactured by Clariant K. K. Japan) as an inorganic fine particle to the toner in embodiment 1, a toner (developer) was formed and evaluated in the same manner as embodiment 1.

Embodiment 9

Other than the fact of adding HDH-H2000 of 1.0 wt % (first particle diameter: 12 nm, manufactured by Clariant K. K. Japan) as an inorganic fine particle to the toner in embodiment 7, a toner (developer) was formed and evaluated in the same manner as embodiment 7.

### COMPARATIVE EXAMPLE 3

Other than the fact of adding HDH-H2000 of 1.0 wt % (first particle diameter: 12 nm, manufactured by Clariant K. K. Japan) as an inorganic fine particle to Toner 1 for each color, a toner (developer) was formed and evaluated in the same manner as embodiment 1.

### COMPARATIVE EXAMPLE 4

Other than the fact of adding HDH-H2000 of 1.0 wt % (first particle diameter: 12 nm, manufactured by Clariant K. K. Japan) as an inorganic fine particle to Toner 5 for each color, a toner (developer) was formed and evaluated in the same manner as embodiment 3.

Embodiment 10

Other than the fact of using evaluation machine B, evaluation was performed in the same manner as embodiment 1.

Embodiment 11

Other than the fact of using evaluation machine C, evaluation was performed in the same manner as embodiment 1.

Embodiment 12

Other than the fact of using evaluation machine D, evaluation was performed in the same manner as embodiment 1.

| | Evaluation | Cleaning | Burial of | Creation of |
|---|---|---|---|---|
| | machine | property | additive | blanks |
| Embodiment 1 | A | ⊚ | ⊚ | Δ |
| Embodiment 2 | A | ◯ | ◯ | ◯ |
| Embodiment 3 | A | Δ | Δ | ◯ |
| Embodiment 4 | A | Δ | Δ | ◯ |
| Embodiment 5 | A | Δ | Δ | Δ |
| Embodiment 6 | A | ◯ | ◯ | Δ |
| Embodiment 7 | A | ◯ | ◯ | ◯ |
| Embodiment 8 | A | ⊚ | ⊚ | ⊚ |
| Embodiment 9 | A | ⊚ | ◯ | ⊚ |
| Embodiment 10 | B | ⊚ | ⊚ | Δ |
| Embodiment 11 | C | ⊚ | ⊚ | Δ |
| Embodiment 12 | D | ⊚ | ⊚ | Δ |
| Comparative | A | ⊚ | ⊚ | X |
| example 1 | | | | |
| Comparative | A | X | X | ◯ |
| example 2 | | | | |
| Comparative | A | ⊚ | ◯ | X |
| example 3 | | | | |
| Comparative | A | X | X | ◯ |
| example 4 | | | | |

| | | Toner | | | |
|---|---|---|---|---|---|
| | Evaluation | transfer | Transfer | Background | Fix- |
| | machine | rate | dust | stain | ability |
| Embodiment 1 | A | Δ | ◯ | ◯ | ⊚ |
| Embodiment 2 | A | ◯ | ◯ | ◯ | ⊚ |
| Embodiment 3 | A | ⊚ | ◯ | Δ | ⊚ |
| Embodiment 4 | A | ◯ | ◯ | Δ | ⊚ |
| Embodiment 5 | A | ◯ | ◯ | ◯ | ⊚ |
| Embodiment 6 | A | ◯ | ⊚ | ⊚ | ◯ |
| Embodiment 7 | A | ◯ | ◯ | ⊚ | ◯ |
| Embodiment 8 | A | ⊚ | ⊚ | ⊚ | ⊚ |
| Embodiment 9 | A | ⊚ | ⊚ | ⊚ | ◯ |
| Embodiment 10 | B | Δ | Δ | ◯ | ⊚ |
| Embodiment 11 | C | Δ | Δ | ◯ | ⊚ |
| Embodiment 12 | D | Δ | Δ | ◯ | ⊚ |
| Comparative | A | X | X | ◯ | ⊚ |
| example 1 | | | | | |
| Comparative | A | ◯ | ◯ | Δ | ⊚ |
| example 2 | | | | | |
| Comparative | A | Δ | Δ | ◯ | ⊚ |
| example 3 | | | | | |
| Comparative | A | ◯ | ◯ | ◯ | ⊚ |
| example 4 | | | | | |

Accordingly, toner shall not be buried into toner even after being agitated in a development unit, developer can sufficiently function as a fluidity agent, a charge support agent, can provide stable image quality, can suitably control adherence among toner particles when compressing and transferring a toner, can provide excellent transferability, developing performance, and fixation, can prevent creation of irregular images for example, images having with blanks, and can prevent transfer dust, can provide excellent transfer rate, and can reduce consumption amount of toner, by providing a developer, including a base toner containing at least a binding resin and a coloring agent; and inorganic fine particles; wherein the base toner satisfies 105≦SF-1≦130 and 120≦SF-2≦180, wherein SF-1=((absolute maximum length of a particle of the base toner)²/area of the particle of the base toner)×(π/4)×100, wherein SF-2=(peripheral length of the particle of the base toner)²/(area of the base toner)×(¼π)×100,

wherein the inorganic fine particles have an average particle diameter that ranges between 30 nm to 160 nm.

Further, the present invention is not limited to these embodiments, but various variations and modifications may be made without departing from the scope of the present invention.

The present application is based on Japanese priority application No. 2002-201970 filed on Jul. 10, 2002 with the Japanese Patent Office, the entire contents of which are hereby incorporated by reference.

What is claimed is

1. A developer, comprising:
a base toner containing at least a binding resin and a coloring agent; and
inorganic fine particles;
wherein the base toner satisfies 105≦SF-1≦130 and 120≦SF-2≦180,
wherein SF-1=((absolute maximum length of a particle of the base toner)²/area of the particle of the base toner)×(π/4)×100,
wherein SF-2=(peripheral length of the particle of the base toner)^{2/}(area of the base toner)×(¼π)×100,
wherein the inorganic fine particles have an average particle diameter that ranges between 30 nm to 160 nm.

2. The developer as claim in claim 1, wherein the inorganic fine particles are formed as silica.

3. The developer as claimed in claim 1, wherein the inorganic fine particles are applied with a sol-gel technique and are thereby formed as spherical shaped hydrophobic silica fine particles.

4. The developer as claimed in claim 1, wherein the developer contains further inorganic fine particles having an average particle diameter which is smaller than the inorganic fine particles.

5. The developer as claimed in claim 1, wherein the developer is combined with a magnetic particle to function as a carrier.

6. An image forming apparatus, comprising:
a developer for developing an electrostatic latent image formed on an electrostatic latent image carrier body to form a toner image;
a transfer unit for transferring the toner image to a transfer medium;
wherein the developer includes a further developer and a carrier,
wherein the further developer has a base toner containing at least a binding resin and a coloring agent, and inorganic fine particles,
wherein the carrier has a magnetic particle,
wherein the base toner satisfies 105≦SF-1≦130 and 120≦SF-2≦180,
wherein SF-1=((absolute maximum length of a particle of the base toner)²/area of the particle of the base toner)×(π/4)×100,
wherein SF-2=(peripheral length of the particle of the base toner)^{2/}(area of the base toner)×(¼π)×100,
wherein the inorganic fine particles have an average particle diameter that ranges between 30 nm to 160 nm.

7. The image forming apparatus as claimed in claim 6, wherein the inorganic fine particles are formed as silica.

8. The image forming apparatus as claimed in claim 6, wherein the inorganic fine particles are applied with a sol-gel technique and are thereby formed as spherical shaped hydrophobic silica fine particles.

9. The image forming apparatus as claimed in claim 6, wherein the developer contains further inorganic fine particles having an average particle diameter which is smaller than the inorganic fine particles.

10. The image forming apparatus as claimed in claim 6, wherein the developer is combined with a magnetic particle to function as a carrier.

11. The image forming apparatus as claimed in claim 6, wherein the developer includes a plurality of colors.

12. A process cartridge, comprising:
a charge unit charging a photoconductor;
an exposure unit exposing light to the photoconductor to form an image on the photoconductor;
a development unit developing the image formed on the photoconductor with a developer;
a transfer unit transferring the image formed on the photoconductor to a transfer medium;
a cleaning unit cleaning the transfer unit;
wherein the developer includes a further developer and a carrier,
wherein the further developer has a base toner containing at least a binding resin and a coloring agent, and inorganic fine particles,
wherein the carrier has a magnetic particle,
wherein the base toner satisfies of 105≦SF-1≦130 and 120≦SF-2≦180,
wherein SF-1=((absolute maximum length of a particle of the base toner)²/area of the particle of the base toner)×( π/4)×100,
wherein SF-2=(peripheral length of the particle of the base toner)^{2/}(area of the base toner)×(¼π)×100,
wherein the inorganic fine particle has an average particle diameter that ranges between 30 nm to 160 nm.

13. The process cartridge as claimed in claim 12, wherein the inorganic fine particles are formed as silica.

14. The process cartridge as claimed in claim 12, wherein the inorganic fine particles are applied with a sol-gel technique and are thereby formed as spherical shaped hydrophobic silica fine particles.

15. The process cartridge as claimed in claim 12, wherein the developer contains further inorganic fine particles having an average particle diameter which is smaller than the inorganic fine particles.

16. The process cartridge as claim in claim 12, wherein the developer is combined with a magnetic particle to function as a carrier.

17. A image forming method, comprising the steps of:
charging a photoconductor;
exposing light to the photoconductor to form an image on the photoconductor;
developing the image formed on the photoconductor with a developer;
transferring the image formed on the photoconductor to a transfer medium;
wherein the developer includes a further developer and a carrier,
wherein the further developer has a base toner containing at least a binding resin and a coloring agent, and inorganic fine particles,
wherein the carrier has a magnetic particle,
wherein the base toner satisfies 105≦SF-1≦130 and 120≦SF-2≦180,
wherein SF-1=((absolute maximum length of a particle of the base toner)²/area of the particle of the base toner)²×(π/4)×100),
wherein SF-2=(peripheral length of the particle of the base toner/area of the base toner)×(¼π)×100,
wherein the inorganic fine particles have an average particle diameter that ranges between 30 nm to 160 nm.

18. The image forming method as claimed in claim 17, wherein the inorganic fine particles are formed as silica.

19. The image forming method as claimed in claim 17, wherein the inorganic fine particles are applied with a sol-gel technique and are thereby formed as spherical shaped hydrophobic silica fine particles.

20. The image forming method as claim in claim 17, wherein the developer contains further inorganic fine particles having an average particle diameter which is smaller than the inorganic fine particles.

21. The image forming method as claim in claim 17, wherein the developer is combined with a magnetic particle to function as a carrier.
